(19) United States
(12) Patent Application Publication
(10) Pub. No.: US 2026/0032711 A1
(43) Pub. Date: Jan. 29, 2026

(54) Mapping Resource Determination Method, User Equipment, and Non-Transitory Readable Storage Medium

(71) Applicant: VIVO MOBILE COMMUNICATION CO., LTD., Dongguan (CN)

(72) Inventors: Yuanyuan Wang, Dongguan (CN); Shuyan Peng, Dongguan (CN); Ye Si, Dongguan (CN); Peng Sun, Dongguan (CN)

(21) Appl. No.: 19/343,401

(22) Filed: Sep. 29, 2025

Related U.S. Application Data
(63) Continuation of application No. PCT/CN2024/086031, filed on Apr. 3, 2024.

(30) Foreign Application Priority Data
Apr. 7, 2023 (CN) 202310367855.7

(51) Int. Cl. H04W 72/40; H04W 72/044

(52) U.S. Cl. CPC H04W 72/40; H04W 72/044

(57) ABSTRACT

A mapping resource determining method includes determining at least one of a pattern or a starting symbol of an SL reference signal based on first information. The first information includes at least one of the following; a total number of symbols used for SL transmission in a slot, resource indication information of the SL reference signal, resource pool type information, or time division multiplexing enable information, the time division multiplexing enable information represents that a slot includes at least two time domain candidate positions or at least two candidate time domain mapping patterns, and the resource pool type information represents a dedicated resource pool or a shared resource pool used for the SL reference signal transmission.

### CROSS-REFERENCE TO RELATED APPLICATIONS

This application is a Bypass Continuation Application of International Patent Application No. PCT/CN2024/086031 filed Apr. 3, 2024, and claims priority to Chinese Patent Application No. 202310367855.7 filed Apr. 7, 2023, the disclosures of which are hereby incorporated by reference in their entireties.

### BACKGROUND OF THE INVENTION

### Field of the Invention

This application pertains to the field of communication technologies, and in particular, relates to a mapping resource determining method, a user equipment, and a non-transitory readable storage medium.

### Description of Related ART

In a new radio (NR) system, sidelink (SL) transmission is supported. Currently, only SL scheduling in a same resource pool or a shared resource pool is supported. For example, an SL positioning reference signal (PRS) can be configured in an SL communication resource pool or a dedicated resource pool.

### SUMMARY OF THE INVENTION

According to a first aspect, a mapping resource determining method is provided. The method includes: determining at least one of a pattern or a starting symbol of an SL reference signal based on first information, where the first information includes at least one of the following: a total number of symbols used for SL transmission in a slot, resource indication information of the SL reference signal, resource pool type information, or time division multiplexing enable information; the time division multiplexing enable information represents that a slot includes at least two time domain candidate positions or at least two candidate time domain mapping patterns; and the resource pool type information represents a dedicated resource pool or a shared resource pool used for transmitting the SL reference signal.

According to a second aspect, a mapping resource determining apparatus is provided. The mapping resource determining apparatus includes a determining module. The determining module is configured to determine at least one of a pattern or a starting symbol of an SL reference signal based on first information, where the first information includes at least one of the following: a total number of symbols used for SL transmission in a slot, resource indication information of the SL reference signal, resource pool type information, or time division multiplexing enable information; the time division multiplexing enable information represents that a slot includes at least two time domain candidate positions or at least two candidate time domain mapping patterns; and the resource pool type information represents a dedicated resource pool or a shared resource pool used for transmitting the SL reference signal.

According to a third aspect, a UE is provided. The UE includes a processor and a memory. The memory stores a program or instructions executable on the processor. When the program or instructions are executed by the processor, the steps of the method according to the first aspect are implemented.

According to a fourth aspect, a UE is provided. The UE includes a processor and a communication interface. The processor is configured to determine at least one of a pattern or a starting symbol of an SL reference signal based on first information, where the first information includes at least one of the following: a total number of symbols used for SL transmission in a slot, resource indication information of the SL reference signal, resource pool type information, or time division multiplexing enable information; the time division multiplexing enable information represents that a slot includes at least two time domain candidate positions or at least two candidate time domain mapping patterns; and the resource pool type information represents a dedicated resource pool or a shared resource pool used for transmitting the SL reference signal.

According to a fifth aspect, a non-transitory readable storage medium is provided. The non-transitory readable storage medium stores a program or instructions. When the program or instructions are executed by a processor, the steps of the method according to the first aspect are implemented.

According to a sixth aspect, a chip is provided. The chip includes a processor and a communication interface. The communication interface is coupled to the processor. The processor is configured to run a program or instructions to implement the method according to the first aspect.

According to a seventh aspect, a computer program or program product is provided. The computer program or program product is stored in a non-transitory storage medium. The computer program or program product is executed by at least one processor to implement the steps of the mapping resource determining method according to the first aspect.

### BRIEF DESCRIPTION OF THE DRAWINGS

FIG. 1 is a schematic architectural diagram of a wireless communication system according to an embodiment of this application;

FIG. 2 is a schematic diagram illustrating symbols in a slot according to the general art;

FIG. 3 is a flowchart of a mapping resource determining method according to an embodiment of this application;

FIG. 4A is a first schematic diagram of an example of an SL-PRS mapping mode according to an embodiment of this application;

FIG. 4B is a second schematic diagram of an example of an SL-PRS mapping mode according to an embodiment of this application;

FIG. 4C is a third schematic diagram of an example of an SL-PRS mapping mode according to an embodiment of this application;

FIG. 5A is a fourth schematic diagram of an example of an SL-PRS mapping mode according to an embodiment of this application;

FIG. 5B is a fifth schematic diagram of an example of an SL-PRS mapping mode according to an embodiment of this application;

FIG. 6A is a sixth schematic diagram of an example of an SL-PRS mapping mode according to an embodiment of this application;

FIG. 6B is a seventh schematic diagram of an example of an SL-PRS mapping mode according to an embodiment of this application;

FIG. 7A is an eighth schematic diagram of an example of an SL-PRS mapping mode according to an embodiment of this application;

FIG. 8A is a ninth schematic diagram of an example of an SL-PRS mapping mode according to an embodiment of this application;

FIG. 8B is a tenth schematic diagram of an example of an SL-PRS mapping mode according to an embodiment of this application;

FIG. 9A is an eleventh schematic diagram of an example of an SL-PRS mapping mode according to an embodiment of this application;

FIG. 9B is a twelfth schematic diagram of an example of an SL-PRS mapping mode according to an embodiment of this application;

FIG. 9C is a thirteenth schematic diagram of an example of an SL-PRS mapping mode according to an embodiment of this application;

FIG. 9D is a fourteenth schematic diagram of an example of an SL-PRS mapping mode according to an embodiment of this application;

FIG. 9E is a fifteenth schematic diagram of an example of an SL-PRS mapping mode according to an embodiment of this application;

FIG. 9F is a sixteenth schematic diagram of an example of an SL-PRS mapping mode according to an embodiment of this application;

FIG. 9G is a seventeenth schematic diagram of an example of an SL-PRS mapping mode according to an embodiment of this application;

FIG. 10A is an eighteenth schematic diagram of an example of an SL-PRS mapping mode according to an embodiment of this application;

FIG. 11A is a nineteenth schematic diagram of an example of an SL-PRS mapping mode according to an embodiment of this application;

FIG. 11B is a twentieth schematic diagram of an example of an SL-PRS mapping mode according to an embodiment of this application;

FIG. 12A is a twenty-first schematic diagram of an example of an SL-PRS mapping mode according to an embodiment of this application;

FIG. 12B is a twenty-second schematic diagram of an example of an SL-PRS mapping mode according to an embodiment of this application;

FIG. 12C is a twenty-third schematic diagram of an example of an SL-PRS mapping mode according to an embodiment of this application;

FIG. 13A is a twenty-fourth schematic diagram of an example of an SL-PRS mapping mode according to an embodiment of this application;

FIG. 13B is a twenty-fifth schematic diagram of an example of an SL-PRS mapping mode according to an embodiment of this application;

FIG. 14A is a twenty-sixth schematic diagram of an example of an SL-PRS mapping mode according to an embodiment of this application;

FIG. 14B is a twenty-seventh schematic diagram of an example of an SL-PRS mapping mode according to an embodiment of this application;

FIG. 14C is a twenty-eighth schematic diagram of an example of an SL-PRS mapping mode according to an embodiment of this application;

FIG. 14D is a twenty-ninth schematic diagram of an example of an SL-PRS mapping mode according to an embodiment of this application;

FIG. 14E is a thirtieth schematic diagram of an example of an SL-PRS mapping mode according to an embodiment of this application;

FIG. 15A is a thirty-first schematic diagram of an example of an SL-PRS mapping mode according to an embodiment of this application;

FIG. 15B is a thirty-second schematic diagram of an example of an SL-PRS mapping mode according to an embodiment of this application;

FIG. 15C is a thirty-third schematic diagram of an example of an SL-PRS mapping mode according to an embodiment of this application;

FIG. 16A is a thirty-fourth schematic diagram of an example of an SL-PRS mapping mode according to an embodiment of this application;

FIG. 16B is a thirty-fifth schematic diagram of an example of an SL-PRS mapping mode according to an embodiment of this application;

FIG. 16C is a thirty-sixth schematic diagram of an example of an SL-PRS mapping mode according to an embodiment of this application;

FIG. 17A is a thirty-seventh schematic diagram of an example of an SL-PRS mapping mode according to an embodiment of this application;

FIG. 17B is a thirty-eighth schematic diagram of an example of an SL-PRS mapping mode according to an embodiment of this application;

FIG. 17C is a thirty-ninth schematic diagram of an example of an SL-PRS mapping mode according to an embodiment of this application;

FIG. 17D is a fortieth schematic diagram of an example of an SL-PRS mapping mode according to an embodiment of this application;

FIG. 18A is a forty-first schematic diagram of an example of an SL-PRS mapping mode according to an embodiment of this application;

FIG. 18B is a forty-second schematic diagram of an example of an SL-PRS mapping mode according to an embodiment of this application;

FIG. 18C is a forty-third schematic diagram of an example of an SL-PRS mapping mode according to an embodiment of this application;

FIG. 19A is a forty-fourth schematic diagram of an example of an SL-PRS mapping mode according to an embodiment of this application;

FIG. 19B is a forty-fifth schematic diagram of an example of an SL-PRS mapping mode according to an embodiment of this application;

FIG. 19C is a forty-sixth schematic diagram of an example of an SL-PRS mapping mode according to an embodiment of this application;

FIG. 19D is a forty-seventh schematic diagram of an example of an SL-PRS mapping mode according to an embodiment of this application;

FIG. 20 is a schematic diagram of a structure of a mapping resource determining apparatus according to an embodiment of this application;

FIG. 21 is a schematic diagram of a hardware structure of a communication device according to an embodiment of this application; and

FIG. 22 is a schematic diagram of a hardware structure of UE according to an embodiment of this application.

### DESCRIPTION OF THE INVENTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this application are used to distinguish between similar objects instead of describing a specified order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a number of objects is not limited. For example, there may be one or more first objects. In addition, the term “or” in this application indicates at least one of connected objects. For example, “A or B” covers three schemes, that is, scheme 1: including A and excluding B; scheme 2: including B and excluding A; and scheme 3: including both A and B. The character “/” generally indicates an “or” relationship between associated objects. The term “indication” in this application may be either a direct indication (or an explicit indication) or an indirect indication (or an implicit indication). The direct indication may be understood as follows: A sender explicitly notifies a receiver, in a sent indication, of content such as information, an operation to be performed, or a result being requested. The indirect indication may be understood as follows: A receiver determines corresponding information based on an indication sent by a sender, or makes a decision and determines, based on a decision result, an operation to be performed or a result being requested, or the like.

It should be noted that technologies described in the embodiments of this application are not limited to a long term evolution (LTE)/LTE-Advanced (LTE-A) system, and can also be used in other wireless communication systems, such as code division multiple access (CDMA), time division multiple access (TDMA), frequency division multiple access (FDMA), orthogonal frequency division multiple access (OFDMA), single-carrier frequency-division multiple access (SC-FDMA), or other systems. The terms “system” and “network” in the embodiments of this application are usually used interchangeably. The described technologies may be used for the foregoing systems and radio technologies, and may also be used for other systems and radio technologies. However, in the following descriptions, the new radio (NR) system is described for an illustrative purpose, and NR terms are used in most of the following descriptions. These technologies may also be applied to other systems than the NR system, for example, a 6th Generation (6G) communication system.

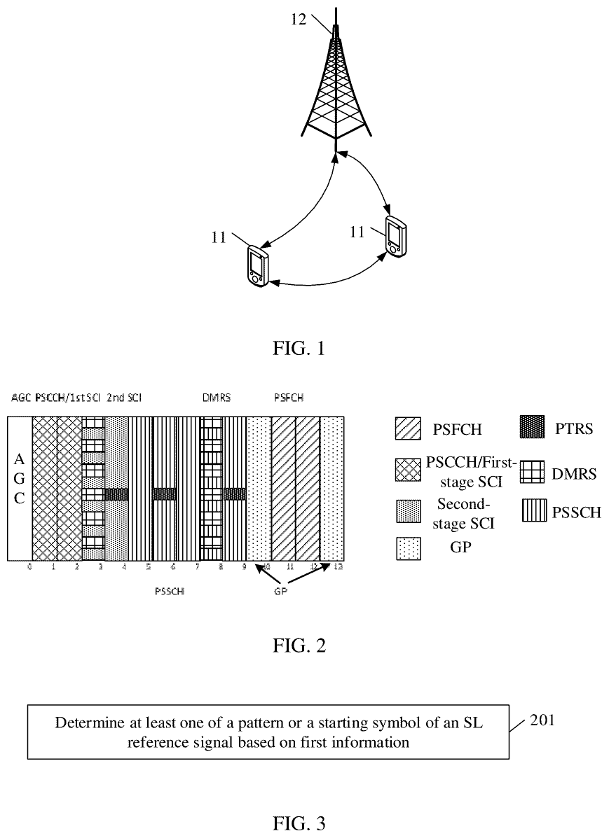

FIG. 1 is a block diagram of a wireless communication system to which an embodiment of this application may be applied. The wireless communication system includes UE 11 and a network-side device 12. The UE 11 may be a terminal-side device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, a flight vehicle, vehicle user equipment (VUE), shipborne equipment, pedestrian user equipment (PUE), a smart home (a home device having a wireless communication function, such as a refrigerator, a television, a washing machine, or furniture), a game console, a personal computer (PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a type of the UE 11 is not limited in the embodiments of this application. The network-side device 12 may include an access network device or a core network device. The access network device may also be referred to as a radio access network (RAN) device, a radio access network function, or a radio access network element. The access network device may include a base station, a wireless local area network (WLAN) access point (AS), a wireless fidelity (Wi-Fi) node, or the like. The base station may be referred to as a NodeB (NB), an evolved NodeB (eNB), a next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the art. As long as the same technical effect is achieved, the base station is not limited to specific technical terms. It should be noted that in the embodiments of this application, only a base station in an NR system is used as an example, but a type of the base station is not limited.

The following describes some concepts or terms related to a mapping resource determining method and apparatus, user equipment, and a non-transitory storage medium provided in the embodiments of this application.
1. SL: An NR system supports sidelink (side link, SL, or the like) transmission, for direct data transmission between user equipments (UE) without a network device. The 5G NR system supports unicast, multicast, or broadcast transmission.
2. R17 SCI indication information

In an R17 SL, a two-stage SCI design is defined. First-stage SCI (that is, SCI format 1-A) is carried in a physical sidelink control channel (PSCCH) and carries the following content: a priority, frequency domain resource allocation, time domain resource allocation, a resource reservation period, a demodulation reference signal (DMRS) pattern, a second-stage SCI format, a beta offset value indication, a number of DMRS ports, a modulation and coding scheme (MCS), an MCS table indication, a PSFCH overhead indication, reservation, and a collision information reception flag.

Second-stage SCI (that is, SCI format 2-A, SCI format 2-B, and SCI format 2-C) is carried in a PSSCH. A format of the second-stage SCI is indicated by the first-stage SCI. The second-stage SCI is mapped starting from a symbol of a first DMRS carried in the PSSCH, in ascending order of symbols of the PSSCH.

The SCI format 2-A is used for decoding the PSSCH, and considered feedback information includes acknowledgement (ACK) and negative acknowledgement (NACK) scenarios, or a NACK-only feedback scenario, or a no-feedback scenario. Carried content is as follows: a hybrid automatic repeat request (HARQ) process number, a new data indicator, a redundancy version, a source identifier (Source ID), a destination identifier (Destination ID), a HARQ feedback enabled/disabled indicator, a cast type indicator, and a channel state information (CSI) request.

The SCI format 2-B is used for decoding the PSSCH, and a scenario with only NACK feedback information or a scenario without feedback information is considered. Carried content is as follows: a HARQ process number, a new data indicator, a redundancy version, a source identifier, a destination ID, a HARQ feedback enabled/disabled indicator, a zone identifier (zone ID), and a communication range requirement.

The SCI format 2-C is used for decoding the PSSCH, and carries coordination information between UEs or a coordination information request between UEs. Carried content is as follows: a HARQ process number, a new data indicator, a redundancy version, a source identifier, a destination ID, a HARQ feedback enabled/disabled indicator, a CSI request, and a providing/requesting indicator. When “providing/requesting indicator” is 0, resource combinations, a first resource position, a reference slot position, a resource set type, and lowest subchannel indices are further included. When “providing/requesting indicator” is 1, a priority, a number of subchannels, a resource reservation period, a resource selection window position (resource selection window location), a resource set type, and a padding bit are further included.

The first-stage SCI is carried in the PSCCH, and the second-stage SCI is carried in the PSSCH.
3. R18 SL positioning

In an existing discussion, an SL-PRS signal is introduced for SL positioning. The SL-PRS signal may be located in a dedicated resource pool or a shared resource pool. If the SL-PRS signal is located in an SL-PRS dedicated resource pool, the following two cases may exist in the SL-PRS dedicated resource pool. Opt 1: Only the SL-PRS signal exists. Opt 2: The PSCCH and the SL-PRS signal exist.

If the SL-PRS signal is located in a shared resource pool, backward compatibility with an SL service needs to be considered, that is, information is transmitted in a same resource pool as in R16/R17, and impact on transmission performance of R16/R17 UE is reduced.

SL shared resource pool slot structure: A number of symbols of one SL slot may be 7 to 14 symbols. FIG. 2 is a schematic diagram of 14 symbols.
1. A period of a physical sidelink feedback channel (PSFCH) is indicated by a resource pool, the period P may be 0, 1, 2, or 4 slots, and some slots may include no PSFCH.
2. A first symbol is automatic gain control (AGC), and a last symbol is definitely used for a guard period (gap).
3. The PSCCH may occupy two or three symbols, such as the first two or three.
4. The PSSCH optionally occupies 6 to 13 symbols, in combination with a pattern and a symbol of a DMRS of the PSSCH.

A mapping resource determining method provided in the embodiments of this application is hereinafter described in detail by using some embodiments and application scenarios thereof with reference to the accompanying drawings.

In an R17 SL, only SL scheduling in a same resource pool is supported. Currently, an SL-PRS can be configured in an SL communication resource pool (SL communication resource pool=shared resource pool) or a dedicated resource pool. In the shared resource pool, compatibility with Release (R)16/R17 SL UE and a requirement of the SL-PRS for a large bandwidth need to be considered. R16/R17 UE performs resource exclusion (an excluded resource is regarded as a resource position of a physical sidelink shared channel (PSSCH)) based on time-frequency domain resource information indicated by first-stage sidelink control information (SCI). However, R18 UE needs to transmit an SL-PRS and PSSCH information (including second-stage SCI) within time-frequency domain resources indicated by the first-stage SCI. However, a frequency domain resource position of the PSSCH is not necessarily the same as a frequency domain resource position of the SL-PRS. In addition, considering that the SL-PRS can be reused in a slot, and resources of a PSCCH or second-stage SCI can be reused between UEs, a mapping relationship between the PSCCH and the SL-PRS needs to be redefined.

In addition, if cross resource pool scheduling of resources in the dedicated resource pool by SCI in the shared resource pool is supported, a resource indication manner needs to be defined.

In addition, in the SL, a resource indication of an SL CSI-RS needs to be defined.

Therefore, how to design a resource structure of the SL-PRS to ensure maximum resource utilization of a resource pool with different symbols is an urgent problem to be resolved.

In a mapping resource determining method provided in an embodiment of this application, UE may determine at least one of a pattern or a starting symbol of an SL reference signal based on first information, where the first information includes at least one of the following: a total number of symbols used for SL transmission in a slot, resource indication information of the SL reference signal, resource pool type information, or time division multiplexing enable information. Therefore, by designing a resource structure of the SL reference signal, this solution can maximize resource utilization of a resource pool with different symbols. In addition, in a shared resource pool, backward compatibility with R16/R17 UE in the shared resource pool is ensured, and sharing for SL positioning in the shared resource pool for R18 UE.

It may be understood that this embodiment of this application may include patterns of a plurality of candidate SL reference signals. Therefore, it is necessary to determine a pattern of an SL reference signal used by the UE. The patterns of the plurality of candidate SL reference signals may be as follows: Different patterns of candidate SL reference signals are used in different resource pools, or different patterns of candidate SL reference signals are used for different total numbers of symbols for SL transmission, or the patterns of the plurality of candidate SL reference signals are included in one resource pool.

It may be understood that the patterns of the plurality of candidate SL reference signals included in this embodiment of this application may be static or dynamic. “Static” means that, in the resource pool, patterns of candidate SL reference signals that can be selected by different UEs have been determined. For example, a time domain position of a PSCCH in the resource pool has been determined, and all UEs can only be mapped to the same time domain position. “Dynamic” means that, in the resource pool, patterns of target SL reference signals selected by different UEs may be different. For example, there are RE offsets between different SL reference signals.

It may be understood that, in an embodiment of this application, the pattern of the SL reference signal may be determined based on a predefined rule and a preconfigured pattern in combination with the first information. The predefined rule may be determined by a protocol based on one or more parameters, or the preconfigured pattern may be included in higher layer signaling.

It may be understood that, in an embodiment of this application, as receiving UE, the UE may determine a pattern of a received SL reference signal based on the first information and information in SCI. Optionally, the SCI includes at least one of the pattern or a starting symbol of the received SL reference signal.

It may be understood that, in an embodiment of this application, as transmitting UE, the UE may obtain at least one of a pattern or a starting symbol of a candidate SL reference signal based on the first information and resource detection. Optionally, the resource detection includes at least one of the following: the transmitting UE detects RSRP of SL-PRSs with different RE offsets to determine patterns of candidate SL reference signals; the transmitting UE detects RSRP of SL-PRSs with different starting symbols to determine starting symbols of candidate SL reference signals.

An embodiment of this application provides a mapping resource determining method. FIG. 3 is a flowchart of a mapping resource determining method according to an embodiment of this application. The method may be performed by UE or a mapping resource determining apparatus. As shown in FIG. 3, the mapping resource determining method provided in this embodiment of this application may include the following step 201.

Step 201: Determine at least one of a pattern or a starting symbol of an SL reference signal based on first information.

In this embodiment of this application, the first information includes at least one of the following: a total number of symbols used for SL transmission in a slot, resource indication information of the SL reference signal, resource pool type information, or time division multiplexing enable information; the time division multiplexing enable information represents that a slot includes at least two time domain candidate positions or at least two candidate time domain mapping patterns; and the resource pool type information represents a dedicated resource pool or a shared resource pool used for transmitting the SL reference signal.

Optionally, in this embodiment of this application, the SL reference signal includes but is not limited to at least one of the following: an SL-PRS or an SL channel state information-reference signal (CSI-RS). In the following examples and implementations, an SL-PRS is used as an illustrative example.

Optionally, in this embodiment of this application, patterns of the foregoing SL reference signals are at least two patterns, and the pattern in this embodiment of this application is an SL reference signal pattern, that is, a mapping mode of the SL reference signal. The mapping mode of the SL reference signal includes at least one of the following: a time domain position of the SL reference signal, a number of symbols for time domain mapping of the SL reference signal, a mapping relationship between the SL reference signal and a PSCCH, a mapping relationship between the SL reference signal and a PSSCH, or a mapping relationship between the SL reference signal and a DMRS. For examples of some implementations, refer to the following implementations 2 and 3.

Optionally, in this embodiment of this application, a value range of the total number of symbols used for SL transmission in the slot may be 7 to 14 symbols.

Optionally, in this embodiment of this application, the symbols used for SL transmission in the slot are all symbols in the slot, or the symbols used for SL transmission in the slot are symbols actually used for SL reference signal transmission, which may be understood as remaining symbols obtained by subtracting at least one of the following: a GP symbol, an ACG symbol, a PSSCH symbol, a DMRS symbol, a PSCCH symbol, or the like.

In this embodiment of this application, the resource indication information of the SL reference signal is used to indicate one of a plurality of SL reference signal patterns.

Optionally, in this embodiment of this application, the time division multiplexing (TDM) mapping enable information indicates that more than one time domain mapping pattern can be mapped in a slot or a resource pool.

Optionally, if the first information includes the total number of symbols used for SL transmission in the slot, the first information is located in configuration information of an SL-BWP, and optionally, the value range of the total number of symbols used for SL transmission may be 7 to 14 symbols.

Optionally, the first information is included in resource pool configuration information. Optionally, in an embodiment, the resource pool configuration information includes resource indication information of one or more SL reference signals and time division multiplexing enable information.

Optionally, the first information includes the resource pool type information, and configuration information for configuring a dedicated resource pool or configuration information for configuring an SL resource pool may indicate whether the resource pool is a dedicated resource pool or a shared resource pool.

Optionally, in this embodiment of this application, “determining a pattern of an SL reference signal based on first information” in the foregoing step 201 may be implemented by at least one of the following steps 201a1, 201a2, or 201a3.
Step 201a1: Determine a time domain mapping pattern of a control channel and the SL reference signal in the slot based on the first information.
Step 201a2: Determine a frequency domain mapping pattern of a control channel and the SL reference signal in the slot based on the first information.
Step 201a3: Determine a mapping relationship between patterns of a control channel and the SL reference signal in the slot based on the first information.

It should be noted that the control channel in this embodiment of this application is a control channel used for SL transmission, such as a sidelink control channel (SCI) or a PSCCH.

It should be noted that, in an optional embodiment, the SCI includes one or more of the following: resource indication information of an SL reference signal associated with the SCI, a pattern of the SL reference signal associated with the SCI, and a starting symbol of the SL reference signal associated with the SCI. The pattern of the SL reference signal associated with the SCI may include at least one of the following: the starting symbol of the SL reference signal, a comb size N of the SL reference signal, or an RE offset of the SL reference signal.

It should be noted that, in an optional embodiment, the determining a mapping pattern of a control channel and the SL reference signal in the slot includes: determining the time domain mapping pattern of the control channel and the SL reference signal in the slot, or determining the mapping relationship between the patterns of the control channel and the SL reference signal in the slot.

Optionally, in this embodiment of this application, the time domain mapping pattern of the control channel and the SL reference signal in the slot includes at least one of the following time domain mapping patterns: a first type of time domain mapping pattern; a second type of time domain mapping pattern; or a third type of time domain mapping pattern. The first type includes a time domain position of a control channel with N1 symbols and at least two time domain positions of SL reference signals, where the control channel with N1 symbols is mapped to first N1 symbols in the slot, a GP symbol exists between the at least two time domain positions of the SL reference signals, and N1 is a positive integer less than or equal to N.

It should be noted that, that there is a GP symbol between the at least two time domain positions of the SL reference signals may be understood as: each SL reference signal is associated with a GP symbol. It may also be understood as: the slot includes a plurality of GP symbols.

The second type includes a time domain position of a control channel with N1 symbols and at least two time domain positions of SL reference signals, where the control channel with N1 symbols is mapped to first N1 symbols in the slot, no GP symbol exists between the at least two time domain positions of the SL reference signals, and N1 is a positive integer less than or equal to N.

It should be noted that, that no GP symbol exists between the at least two time domain positions of the SL reference signals may be understood as: only one GP symbol is included in one slot, and the GP symbol is located at a last symbol of the slot.

Optionally, in this embodiment of this application, if the resource pool is a first type or a second type of resource pool, the resource pool configuration information includes at least one of the following: a number of symbols of the PSCCH, a number of symbols of the GP, or configuration information of the SL reference signal.

The third type is that the slot is divided into two mini-slots (mini-slot), where each mini-slot includes a control channel and an SL reference signal.

Optionally, in this embodiment of this application, the control channel in the mini-slot is associated with the SL reference signal of the current mini-slot. In an optional embodiment, one slot includes a first mini-slot and a second mini-slot.

Optionally, the first mini-slot cannot schedule a resource in the second mini-slot in the current slot.

Optionally, a control channel in the first mini-slot cannot be associated with an SL reference signal resource in the second mini-slot in the current slot. Alternatively, the second mini-slot cannot schedule a resource in the first mini-slot in the current slot.

Optionally, a control channel in the second mini-slot cannot be associated with an SL reference signal resource in the first mini-slot in the current slot.

Optionally, if the resource pool is a third type of resource pool, the resource pool includes configuration information of a mini-slot. The configuration information of the mini-slot includes at least one of the following: indication information of the mini-slot, a number of symbols of a PSCCH in the mini-slot, or configuration information of an SL reference signal included in the mini-slot.

Optionally, in this embodiment of this application, based on the total number of symbols in the slot, it is possible to determine to apply one or more of the first type, the second type, or the third type.

Optionally, in an embodiment, if all the symbols in the slot are determined, the time domain mapping pattern is also determined. For example, a time domain mapping pattern of odd symbols is determined as the first type of time domain mapping pattern.

Optionally, in an embodiment, a variety of time domain mapping patterns may be included in the corresponding slot. In this case, the time domain mapping pattern of the resource pool may alternatively be determined based on configuration information. For example, for the resource pool, one of the second type or the third type is indicated as the time domain mapping pattern of the control channel and the SL reference signal in the slot.

Optionally, in this embodiment of this application, for odd symbols in the slot, a time domain mapping pattern of the odd symbols is the first type of time domain mapping pattern.

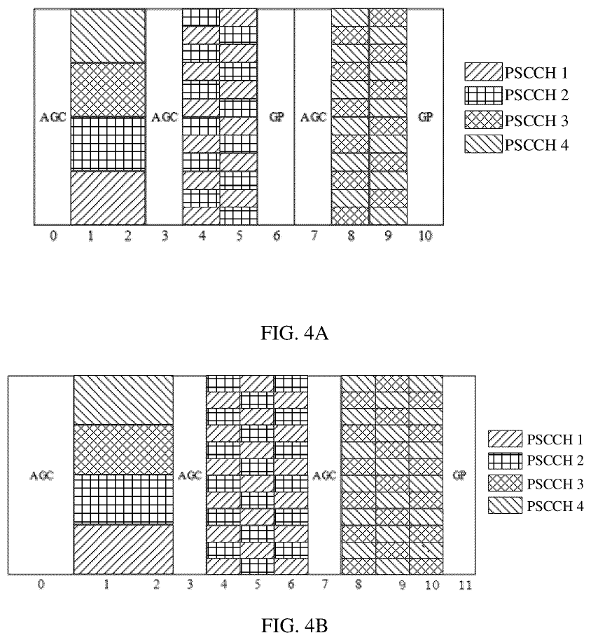

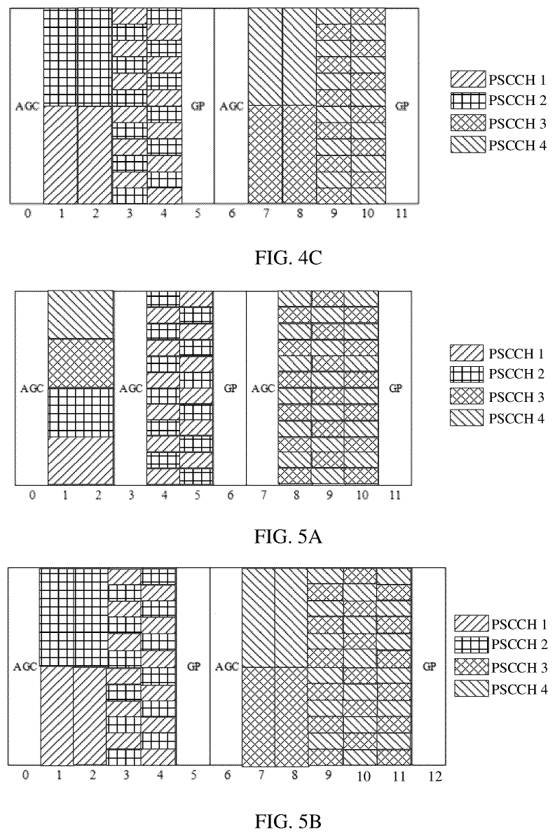

For example, as shown in FIG. 4A, for odd symbols in a slot, the control channel with N1 symbols is mapped to first N1 symbols of the slot. For example, a value of N1 may be the first two or three symbols, where the first two or three symbols are first two or three symbols after a symbol 0 is excluded, because the symbol 0 is an AGC symbol for a symbol 1. In addition, that a GP symbol exists between the at least two time domain positions of the SL reference signals may be understood as: if at least two time domain positions of SL reference signals are included, two GP symbols are included between the at least two time domain positions of the SL reference signals. One or more pieces of control information (such as different padding) are associated with SL reference signals (same padding) at different time-frequency positions. It should be noted that an association of same padding in each figure is illustrative. An association with a fixed offset from that in the figure shall also fall within the protection scope of this application.

Optionally, in this embodiment of this application, for even symbols in the slot, a time domain mapping pattern of the even symbols is the second type of time domain mapping pattern. Alternatively, for even symbols in the slot, a time domain mapping pattern of the even symbols is the third type of time domain mapping pattern.

For example, as shown in FIG. 4B, one slot includes a plurality of AGC symbols and one GP symbol. For even symbols in the slot, a control channel with N1 symbols is mapped to first N1 symbols of the slot. For example, a value of NI may be first two or three symbols, where the first two or three symbols are first two or three symbols after a symbol 0 is excluded, because the symbol 0 is an AGC symbol for a symbol 1. In addition, no GP symbol exists between at least two time domain positions of SL reference signals. It may be understood that if the two time domain positions of the SL reference signals are included, still only one GP symbol is included. The one GP symbol is located at a last symbol of the slot. One or more pieces of control information (such as different padding) are associated with SL reference signals (same padding) at different time-frequency positions.

For another example, as shown in FIG. 4C, for even symbols in a slot, one slot is divided into two mini-slots, such as a first mini-slot and a second mini-slot, and each mini-slot includes a control channel and an SL reference signal. The control channel of the current mini-slot can only be associated with the SL reference signal in the current mini-slot in the current slot, where a time domain pattern of each SL reference signal corresponds to a time domain position of the control channel of the current mini-slot. Optionally, the control channel of the current mini-slot can also be used to reserve a resource of an SL reference signal in a subsequent slot.

In an optional embodiment, the resource reserved for the SL reference signal in the subsequent slot may come from the first mini-slot or the second mini-slot. For example, the control channel includes slot offset information and mini-slot indication information.

In another optional embodiment, the resource reserved for the SL reference signal in the subsequent slot may come from only a mini-slot same as the current slot. For example, the control channel includes slot offset information. The slot offset information is a slot offset from the slot in which the current control information is located.

In still another optional embodiment, the resource reserved for the SL reference signal in the subsequent slot may come from the first mini-slot or the second mini-slot. For example, the control channel includes mini-slot offset indication information. The mini-slot offset information is a mini-slot offset from the mini-slot in which the current control information is located.

Optionally, in this embodiment of this application, in a case that the total number of symbols is greater than N, the slot includes at least two time domain candidate positions of SL reference signals, and N is an integer greater than or equal to 7.

For example, the resource pool includes a plurality of sidelink SL reference signal patterns, and the plurality of sidelink SL reference signal patterns include at least two different time domain candidate positions of SL reference signals. It may be understood that the plurality of sidelink SL reference signal patterns include different starting symbols of SL reference signals.

For example, the value of N may be 10. Optionally, if the total number of symbols is 10, 11, 12, 13, or 14, the slot includes at least two time domain candidate positions of SL reference signals. In other words, TDM time division multiplexing can be supported.

Optionally, in this embodiment of this application, the at least two time domain candidate positions of the SL reference signals have a same SL reference signal pattern. It may be understood that in this case, a same mapping pattern is used for mapping starting symbols (for example, symbols 4 and 8) of different SL reference signals. Optionally, the same mapping pattern is the same (M, N) (that is, single (M, N)), to reduce complexity for the UE, such as complexity of searching or detection (sensing). N is a comb size of the SL reference signal; and M is a number of symbols of the SL reference signal. Optionally, N is one or more of 1, 2, 4, 6, and 12; and M is one or more of 1, 2, 3, 4, 6, and 8. It may be understood that patterns of a plurality or all of the SL reference signals included in the resource pool have the same (M, N).

Optionally, in this embodiment of this application, the SL reference signal pattern includes at least one of the following: a number of symbols of the SL reference signal; a comb size of the SL reference signal; a number of AGC symbols associated with the SL reference signal; a number of GP symbols associated with the SL reference signal; or an association rule between a PSCCH and the SL reference signal.

Optionally, in this embodiment of this application, pattern information of the SL reference signal such as the number of symbols of the SL reference signal or the comb size of the SL reference signal is included in the resource pool configuration information, because different SL reference signal patterns use the same (M, N).

Optionally, in this embodiment of this application, the at least two time domain candidate positions of the SL reference signals have different SL reference signal patterns.

Optionally, in this embodiment of this application, the different SL reference signal patterns are that the SL reference signals have different starting symbols and different numbers of symbols. Optionally, in an embodiment, if a resource pool includes a plurality of SL reference signal patterns, if starting symbols associated with two patterns are different, numbers of symbols associated with the patterns are also different. If starting symbols associated with two patterns are the same, numbers of symbols associated with the patterns are also the same.

Optionally, in an embodiment, the different SL reference signal patterns are that at least one of the comb size or the number of symbols of the SL reference signal is different.

For example, as shown in FIG. 5A, for odd symbols in a slot, numbers of symbols in different SL reference signal patterns are different. For example, two time domain mapping patterns with 12 symbols are {2, 2}+{3, 2}, and {3, 2}+{2, 2}. {2, 2} is {number of symbols, comb size} associated with one time domain pattern in the two time domain mapping patterns, {3, 2} is {number of symbols, comb size} associated with the other time domain pattern in the two time domain mapping patterns, and the numbers of symbols associated with the two time domain mapping patterns are 2 and 3 respectively. Optionally, starting symbols associated with the two time domain mapping patterns are M1 and M2. Optionally, the comb size may alternatively be one of 4, 6, 8, and 12.

For another example, as shown in FIG. 5B, for even symbols in a slot, starting symbols and numbers of symbols in different SL reference signal patterns are different. For example, two time domain mapping patterns with 13 symbols are {2, 2}+{3, 2}, and {3, 2}+{2, 2}. {2, 2} is {number of symbols, comb size} associated with one time domain pattern in the two time domain mapping patterns, {3, 2} is {number of symbols, comb size} associated with the other time domain pattern in the two time domain mapping patterns, and the numbers of symbols associated with the two time domain mapping patterns are 2 and 3 respectively. Optionally, starting symbols associated with the two time domain mapping patterns are M1 and M2. Optionally, the comb size may alternatively be one of 4, 6, 8, and 12.

Optionally, in this embodiment of this application, the SL reference signal patterns include at least two SL reference signal patterns, and the at least two SL reference signal patterns are configured in a same resource pool.

Optionally, in this embodiment of this application, comb sizes of the at least two SL reference signal patterns are the same. In other words, in this embodiment of this application, all SL reference signal patterns in a resource pool have a same comb size. For example, the resource pool configuration information includes the comb size of the SL reference signal, and optionally, the comb size is one of {1, 2, 4, 6, 8, 12}.

Optionally, in this embodiment of this application, the at least two SL reference signal patterns include frequency domain mapping patterns, and the frequency domain mapping pattern includes at least one of a comb size or a resource element (RE) offset.

Optionally, in this embodiment of this application, at least two SL reference signal patterns at the foregoing one time domain position have a same comb size and different resource element (RE) offsets.

It may be understood that if the comb size is 2, the same time domain position includes up to two frequency domain candidate positions of SL reference signals, corresponding to an RE offset 0 and an RE offset 1 respectively. If the comb size is 4, the same time domain position includes up to four frequency domain candidate positions of SL reference signals, corresponding to an RE offset 0, an RE offset 1, an RE offset 2, and an RE offset 3 respectively. If the comb size is 8 or 12, the case can be inferred by analogy.

For example, if one slot includes two time domain candidate positions, such as a starting symbol M1 and a starting symbol M2, and the comb size is 2, the slot includes up to four candidate SL reference signal patterns, which correspond to {starting symbol M1, RE offset 0}, {starting symbol M1, RE offset 1}, {starting symbol M2, RE offset 0}, and {starting symbol M2, RE offset 1} respectively.

For example, if one slot includes two time domain candidate positions, such as a starting symbol M1 and a starting symbol M2, and the comb size is 4, the slot includes up to eight candidate SL reference signal patterns, which correspond to {starting symbol M1, RE offset 0}, {starting symbol M1, RE offset 1}, {starting symbol M1, RE offset 2}, {starting symbol M1, RE offset 3}, {starting symbol M2, RE offset 0}, {starting symbol M2, RE offset 1}, {starting symbol M2, RE offset 2}, and {starting symbol M2, RE offset 3} respectively. If the comb size is 8 or 12, the case can be inferred by analogy.

Optionally, in this embodiment of this application, the slot includes multiple frequency domain mapping patterns, and comb sizes of the multiple frequency domain mapping patterns are the same.

Optionally, in this embodiment of this application, up to K SL reference signal patterns are included in a same resource pool, K is a maximum number of SL reference signal patterns supported in the same resource pool, and K is an integer greater than 1.

Optionally, in this embodiment of this application, each SL reference signal pattern is associated with indication information of an SL reference signal; or
each SL reference signal pattern is associated with an SL reference signal starting symbol of the respective SL reference signal pattern; or
each SL reference signal pattern is associated with an RE offset of the SL reference signal pattern; or
each SL reference signal pattern is associated with a number of symbols of the respective SL reference signal pattern.

For example, the configuration information of the SL reference signal includes K SL reference signal patterns, and each SL reference signal pattern includes indication information of an SL reference signal.

Optionally, each SL reference signal pattern may further include at least one of the following:
an SL reference signal starting symbol, which exists when there are a plurality of candidate SL reference signal starting symbols;
an RE offset of the SL reference signal, which exists when the comb size associated with the SL reference signal is greater than 1; or
a number of symbols of the SL reference signal, which exists when a plurality of numbers of symbols M are configured in a resource pool.

Optionally, in this embodiment of this application, two mini-slots are configured in the resource pool. For example, the two mini-slots are a mini-slot 1 and a mini-slot 2 respectively.

Optionally, in this embodiment of this application, the time domain mapping pattern of the control channel and the SL reference signal in the slot includes a mini-slot structure configuration.

Each mini-slot indicates a number of symbols of the mini-slot; or each mini-slot indicates a time domain mapping pattern of a control channel and an SL reference signal in the mini-slot.

Optionally, in this embodiment of this application, lengths of the mini-slots are the same or different.

Optionally, in this embodiment of this application, in a case that the number of symbols of each mini-slot is the same, at least one of a number of symbols or a comb size of the SL reference signal is the same.

Optionally, in this embodiment of this application, in a case that the number of symbols of each mini-slot is the same, at least one of a number of symbols or a comb size of the SL reference signal is the same, and a number of symbols of a PSCCH is the same.

Optionally, in this embodiment of this application, in a case that the number of symbols of each mini-slot is different, at least one of a number of symbols of the SL reference signal or a number of symbols of a PSCCH is different.

For example, that a number of symbols of a PSCCH is different is: a number of symbols of a PSCCH in a mini-slot 1 is 2, and a number of symbols of a PSCCH in a mini-slot 2 is 3. Optionally, different PSCCH lengths are associated with SL reference signals of a same length. In other words, in this embodiment, two mini-slots are associated with the same (M, N), where M is the number of symbols of the SL reference signal and N is the comb size of the SL reference signal.

Optionally, in this embodiment of this application, each SL reference signal pattern is associated with mini-slot indication information of the SL reference signal pattern, and the mini-slot indication information is used to indicate that the mini-slot is a first mini-slot or a second mini-slot of the slot.

Optionally, in this embodiment of this application, each SL reference signal pattern is associated with indication information of an SL reference signal, where the indication information of the SL reference signal may be of each mini-slot or each slot. For example, the configuration information of the SL reference signal includes configuration information of two mini-slots, and each mini-slot includes configuration information of a plurality of SL reference signal patterns. For example, a mini-slot 1 includes K1 SL reference signal patterns, and a mini-slot 2 includes K2 SL reference signal patterns.

Optionally, in this embodiment of this application, each SL reference signal pattern is associated with an SL reference signal starting symbol of the respective SL reference signal pattern, where the SL reference signal starting symbol is a starting symbol relative to a mini-slot or a starting symbol relative to a slot.

Optionally, in this embodiment of this application, the foregoing step 201 may be implemented by the following step 201b or step 201c.

Step 201b: Determine indication information of the SL reference signal based on the first information and detection of candidate resources for the SL reference signal, where each SL reference signal pattern is associated with indication information of an SL reference signal.

It may be understood that, in a case that one slot includes a plurality of SL reference signal patterns, transmitting UE needs to detect candidate SL reference signal patterns, where the candidate SL reference signal patterns have different SL reference signal starting symbols or different SL reference signal RE offsets. For example, one slot includes two time domain candidate positions, such as a starting symbol M1 and a starting symbol M2, and the comb size is 2. In this case, the slot includes up to four candidate SL reference signal patterns, which are respectively an SL reference signal pattern 0 corresponding to {starting symbol M1, RE offset 0}, an SL reference signal pattern 1 corresponding to {starting symbol M1, RE offset 1}, an SL reference signal pattern 2 corresponding to {starting symbol M2, RE offset 0}, and an SL reference signal pattern 3 corresponding to {starting symbol M2, RE offset 1}. The transmitting UE needs to detect, in each slot, whether the four candidate SL reference signal patterns can be occupied to send the SL reference signal.

Step 201c: Determine, based on the first information and detection of candidate resources for a PSCCH associated with the SL reference signal, a position of the PSCCH associated with the SL reference signal, to determine at least one of the pattern or the starting symbol of the SL reference signal.

It may be understood that, in a case that one slot includes a plurality of SL reference signal patterns, the transmitting UE may determine at least one of the pattern or the starting symbol of the SL reference signal based on detection of candidate resources for the PSCCH associated with the SL reference signal. For example, one slot includes four candidate SL reference signal patterns, which are respectively as follows: A PSCCH 0 position corresponds to an SL reference signal pattern 1, a PSCCH 1 position corresponds to an SL reference signal pattern 2, a PSCCH 2 position corresponds to an SL reference signal pattern 3, and a PSCCH 4 position corresponds to an SL reference signal pattern 4. The transmitting UE needs to detect candidate positions of the four PSCCHs in each slot to determine at least one of the pattern or the starting symbol of the SL reference signal.

Optionally, in this embodiment of this application, after the foregoing step 201b, the mapping resource determining method provided in this embodiment of this application may further include the following step 301.

Step 301: Determine indication information of SCI, where the SCI includes the indication information of the SL reference signal.

Optionally, the indication information of the SCI is determined, where the SCI includes at least one of the pattern or the starting symbol of the SL reference signal. For example, the SCI includes the RE offset and the starting symbol.

Optionally, the SL reference signal and the determined indication information of the SCI are sent in a same slot, and the receiving UE determines, based on the indication information of the SCI, that the SCI includes at least one of the pattern or the starting symbol of the SL reference signal.

Optionally, in this embodiment of this application, after the foregoing step 201b, the mapping resource determining method provided in this embodiment of this application may further include the following step 302.

Step 302: Determine, based on the indication information of the SL reference signal, a frequency domain position or a time domain position of the PSCCH associated with the SL reference signal.

Optionally, in this embodiment of this application, the frequency domain position or the time domain position of the PSCCH includes:
a PSCCH corresponding to i-th indication information of an SL reference signal is located in an i-th PSCCH minimum unit, where i is a positive integer; or a PSCCH corresponding to i-th indication information of an SL reference signal is located in a mod(i+N1, K)-th PSCCH minimum unit, where i is a positive integer, K1 is a maximum frequency domain candidate position of the PSCCH, and N1 is a frequency shift parameter of the PSCCH.

It may be understood that the transmitting UE determines the frequency domain position or time domain position of the PSCCH based on the i-th indication information of the SL reference signal. The receiving UE determines the indication information of the SL reference signal based on the frequency domain position or time domain position of the PSCCH, thereby determining at least one of the pattern or the starting symbol of the SL reference signal.

Optionally, in this embodiment of this application, the minimum unit is a subchannel or an integer multiple of a subchannel.

For example, the indication information of the SL reference signal is 0, and the PSCCH is located in a 0-th subchannel available for transmission, or the PSCCH is located in a first subchannel available for transmission.

Optionally, in this embodiment of this application, the frequency domain position or the time domain position of the PSCCH includes:
in a case that the indication information of the SL reference signal is local information in each mini-slot, a PSCCH corresponding to i-th indication information of an SL reference signal is located in an i-th PSCCH minimum unit in a current mini-slot, where i is a positive integer; or
in a case that the indication information of the SL reference signal is local information in each slot, a PSCCH corresponding to i-th indication information of an SL reference signal is located in a mod(i, F)-th PSCCH minimum unit in a current mini-slot, where i is a positive integer, and F is a maximum number of SL reference signals in a mini-slot.

Optionally, in this embodiment of this application, a time domain mapping pattern of the SL reference signal is determined based on a protocol or a specified table, where the table includes at least one of the following: a number of symbols used for SL transmission in the slot, the starting symbol of the SL reference signal, a number of symbols of the SL reference signal, or a number of symbols of a PSCCH.

Optionally, in this embodiment of this application, the time domain mapping pattern of the SL reference signal may be the starting symbol position or the number of symbols of the SL reference signal.

Optionally, in this embodiment of this application, the specified table includes the starting symbol of the SL reference signal, which is intended for a case that time division multiplexing mapping is not enabled. For example, the starting symbol of the SL reference signal is 3, or the starting symbol of the SL reference signal is 4.

Optionally, in this embodiment of this application, the starting symbol of the SL reference signal is indicated by the resource pool configuration information. Alternatively, the starting symbol of the SL reference signal is determined based on an indication of the number of symbols of the PSCCH. For example, SL reference signal starting symbol=PSCCH length+1, or SL reference signal starting symbol=PSCCH length+2. Alternatively, the starting symbol of the SL reference signal is determined based on an indication of a time domain structure 1 or 2 in the following implementation 1. It may be understood that the starting symbol of the SL reference signal is relative to a symbol 0 in the slot or relative to a last symbol of the PSCCH.

Optionally, in this embodiment of this application, the specified table includes the number of symbols of the SL reference signal, which is intended for a case that time division multiplexing mapping is not enabled. For example, the number of symbols of the SL reference signal is: Slot length—4 (corresponding to a starting symbol 3), or the number of symbols of the SL reference signal is: Slot length—5 (corresponding to a starting symbol 4).

Optionally, in this embodiment of this application, the number of symbols of the SL reference signal is indicated by the resource pool configuration information; or the number of symbols of the SL reference signal is determined based on the indication of the number of symbols of the PSCCH (Number of symbols of the SL reference signal=Number of symbols of the slot-PSCCH length—k11); or the number of symbols of the SL reference signal is determined based on the indication of the time domain structure 1 or 2 in the following implementation 1.

Optionally, in this embodiment of this application, in a case that time division multiplexing mapping is not enabled, the SL reference signal pattern includes only a frequency domain mapping pattern, and the frequency domain mapping pattern is associated with at least one piece of the following information: indication information of the SL reference signal or an RE offset of the SL reference signal pattern.

It may be understood that, in a case that time division multiplexing mapping is not enabled, different SL reference signal patterns have a same (that is, one) number of symbols and starting symbol position. Optionally, in a case of the same number of symbols and starting symbol position, the information may be omitted by default.

Optionally, in this embodiment of this application, the first information includes at least the resource pool type information, and the resource pool type information represents the shared resource pool used for transmitting the SL reference signal. The foregoing step 201 may be implemented by the following step 201d.

Step 201d: In a case that the SL reference signal is mapped to the shared resource pool, determine at least one of the pattern or the starting symbol of the SL reference signal based on whether a symbol used for SL transmission in the slot transmits a PSSCH.

In this embodiment of this application, in a case that the SL reference signal is mapped to the shared resource pool, that is, in a case that the shared resource pool may be used for transmitting the SL reference signal and SL communication data, the pattern of the SL reference signal may be determined based on whether the symbol used for SL transmission in the slot is used for transmission of the PSSCH.

Optionally, in this embodiment of this application, “determining a pattern of an SL reference signal based on first information” in the foregoing step 201 may be implemented by the following step 201e.

Step 201e: In a case that the symbol used for SL transmission in the slot is used for transmission of the PSSCH, determine a mapping pattern of a control channel, the PSSCH, and the SL reference signal in the slot.

Optionally, in this embodiment of this application, the mapping pattern of the SL reference signal in the slot includes a symbol position of the SL reference signal, where the SL reference signal is mapped to M symbols after a first DMRS after a PSCCH, where M is a positive integer; or the SL reference signal is mapped to M symbols between a first DMRS and a second DMRS after a PSCCH, where M is a positive integer.

Optionally, the starting symbol position of the SL reference signal is specified by a protocol, that is, a first or second symbol after the first DMRS after the PSCCH. Optionally, the number of symbols of the SL reference signal is specified by a protocol or configured by a higher layer.

It should be noted that for an example of the mapping pattern of the SL reference signal in the slot herein, reference may be made to case 2 in the following implementation 5.

Optionally, in this embodiment of this application, M is determined based on (pre) configuration information of the resource pool; or M is selected by the UE from resource indication information of a plurality of SL reference signals. M is a number of symbols of the SL reference signal. Optionally, in this embodiment, the comb size N may be one or more comb sizes in the (pre) configuration information of the resource pool. If there are a plurality of comb sizes, at least one of the comb size or the RE offset needs to be indicated in the SCI.

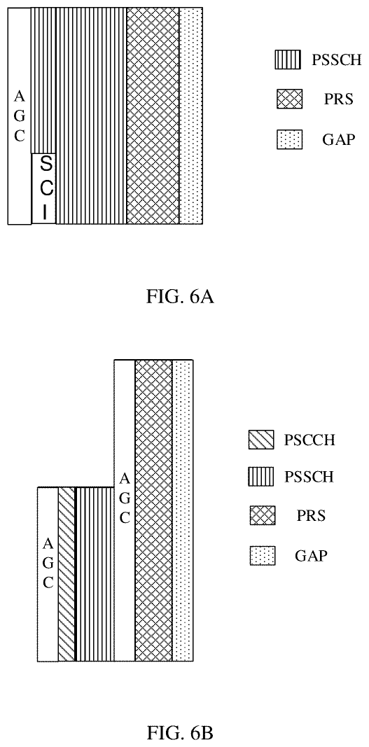

Optionally, in this embodiment of this application, as shown in FIG. 6A, in a case that the SL reference signal is mapped to the M symbols between the first DMRS and the second DMRS after the PSCCH, a time domain length and a comb size of the SL reference signal are provided by a resource pool configuration and determined with reference to positions of the DMRSs.

Optionally, in this embodiment of this application, a mapping pattern of the control channel and the PSSCH in the slot includes one of the following that: there is symbol overlap between the control channel and the PSSCH in the slot; and there is no symbol overlap between the control channel and the PSSCH in the slot.

Optionally, in this embodiment of this application, as shown in FIG. 6B, in a case that there is no symbol overlap between the control channel and the PSSCH in the slot, a bandwidth or a frequency domain position of the PSSCH is the same as that of a PSCCH. For example, a bandwidth of the SL reference signal is different from that of the PSSCH, and the bandwidth and the frequency domain position of the SL reference signal are indicated in first-stage SCI. The bandwidth or the frequency domain position of the PSSCH is determined based on the PSCCH.

Optionally, in this embodiment of this application, in a case that the bandwidth or the frequency domain position of the PSSCH is the same as that of the PSCCH, a multi-user PSCCH can be mapped to a same time domain position but different frequency domain positions, where up to K1 users can be mapped to one slot, and K1 is a maximum frequency domain candidate position of the PSCCH.

Optionally, in this embodiment of this application, as shown in FIG. 6A, in a case that there is symbol overlap between the control channel and the PSSCH in the slot, the bandwidth or the frequency domain position of the PSSCH is the same as that of the SL reference signal. Bandwidths and frequency domain positions of the PSSCH and the SL reference signal are indicated in first-stage SCI.

Optionally, in this embodiment of this application, in a case that the bandwidth or the frequency domain position of the PSSCH is the same as that of the SL reference signal, multi-user multiplexing is not supported within a resource of the SL reference signal.

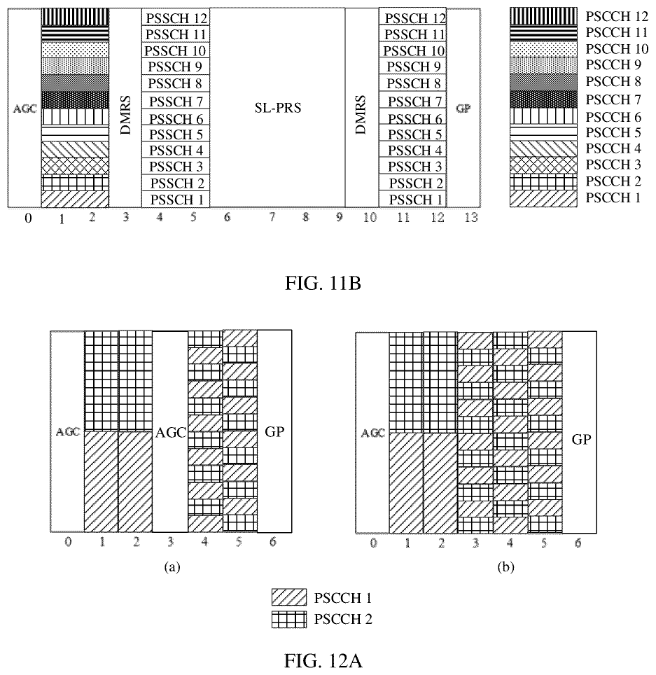

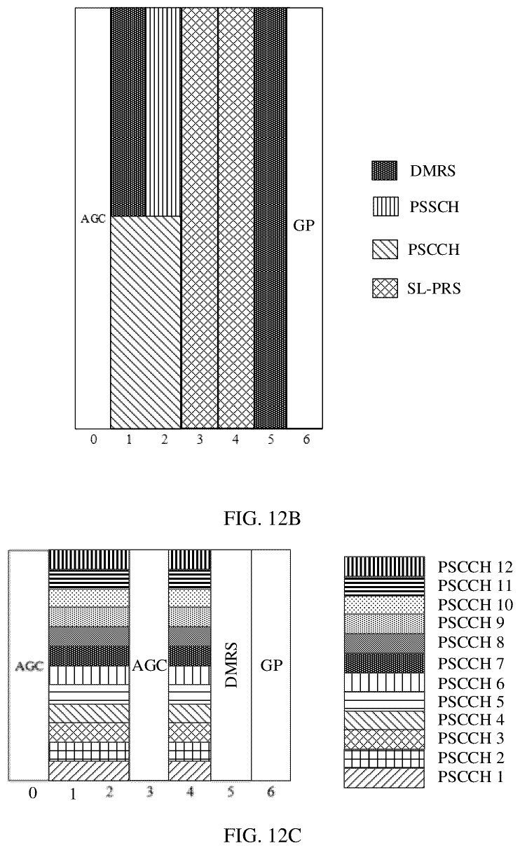

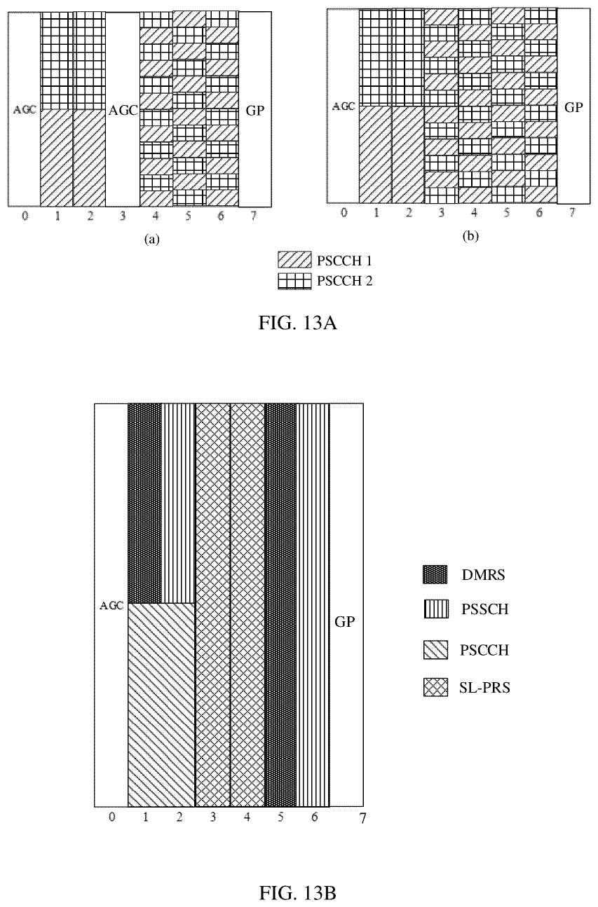

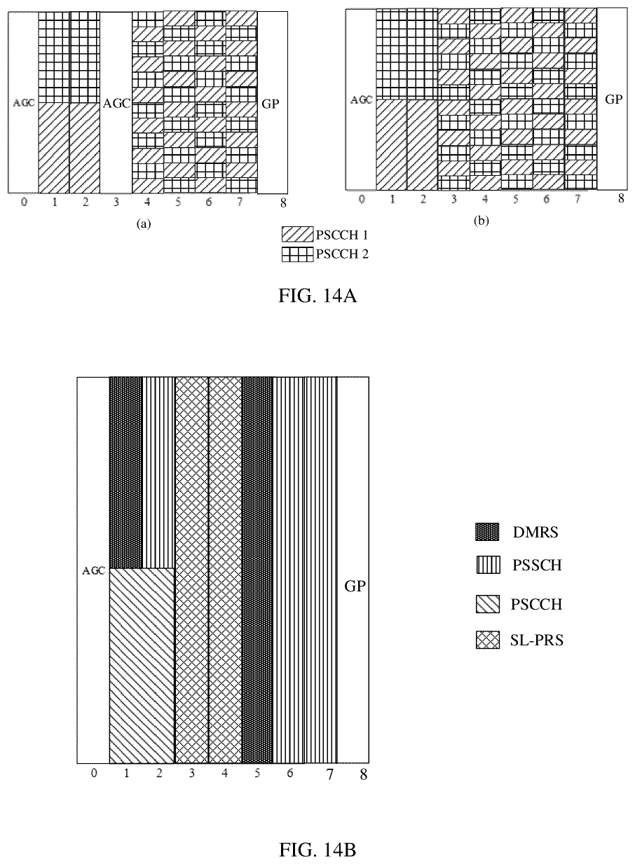

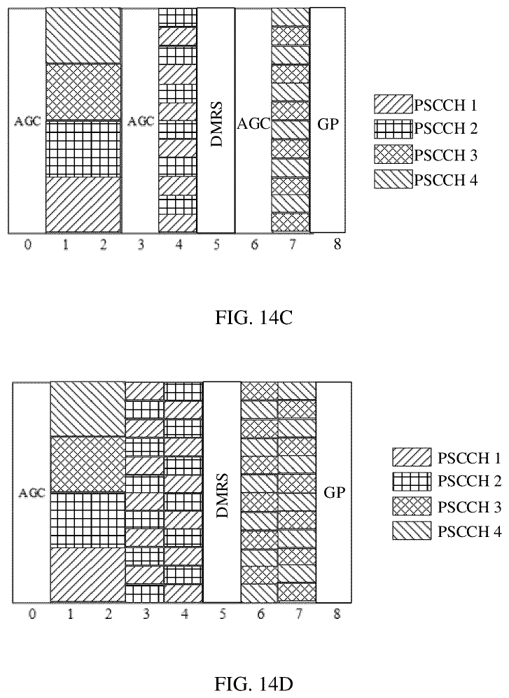

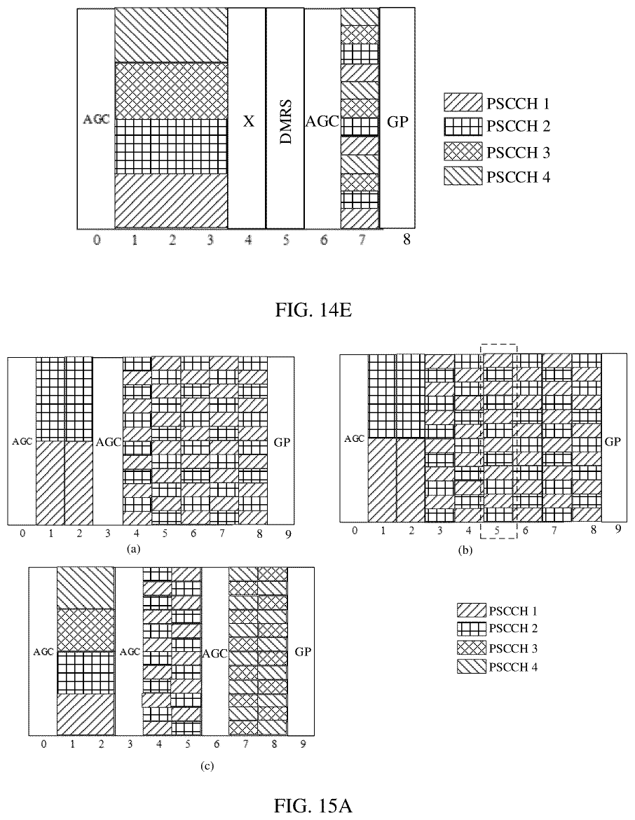

Optionally, in this embodiment of this application, as shown in FIG. 11A, FIG. 12B, FIG. 13B, and FIG. 14B, in a case that detection and resource selection of the shared resource pool are determined based on a DMRS of the PSSCH, and that a symbol of the DMRS includes a first symbol, SL reference signal mapping at a comb level is not supported in the slot.

Optionally, in this embodiment of this application, as shown in FIG. 11A, in a case that detection and resource selection of the shared resource pool are determined based on a DMRS of a PSCCH, frequency division multiplexing (FDM) SL reference signal mapping at a comb level is supported in the slot. Optionally, the bandwidth or the frequency domain position of the PSSCH is the same as that of the PSCCH.

It may be understood that if detection of the shared resource pool is based on a DMRS of the PSSCH (DMRS for PSSCH, that is, sl-RS-ForSensing is configured as the PSSCH), and a symbol of this DMRS includes a symbol 1, comb level (comb-level) SL reference signal mapping (that is, COMB-LEVEL FDM) is not supported in the slot. Conversely, if the SL reference signal is expected to be mapped at the comb level, a structure in which a first symbol carries a DMRS for the PSSCH cannot be selected for the DMRS, that is, a DMRS with an ID of 9 to 13 in Table 1 is expected to be configured.

TABLE 1

| | DMRS position l̅ | | | | | |
|---|---|---|---|---|---|---|
| l_{d} in | PSCCH duration 2 symbols | | | PSCCH duration 3 symbols | | |
| sym- | Number of PSSCH DMRSs | | | Number of PSSCH DMRSs | | |
| bols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

Optionally, in this embodiment of this application, in a case that the detection and resource selection of the shared resource pool are determined based on the DMRS of the PSSCH, FDM SL reference signal transmission at the comb level is not supported in a first resource pool, where the first resource pool is a resource pool in which a number of symbols for the SL reference signal is less than or equal to L, and Lis an integer greater than 7.

It may be understood that, if detection of the shared resource pool is based on the DMRS for the PSSCH, comb-level FDM SL reference signal (ID =6, 7, or 8 in the foregoing Table 1) transmission cannot be performed in a resource pool in which a number sl of symbols is less than or equal to L (for example, a value of L may be 9).

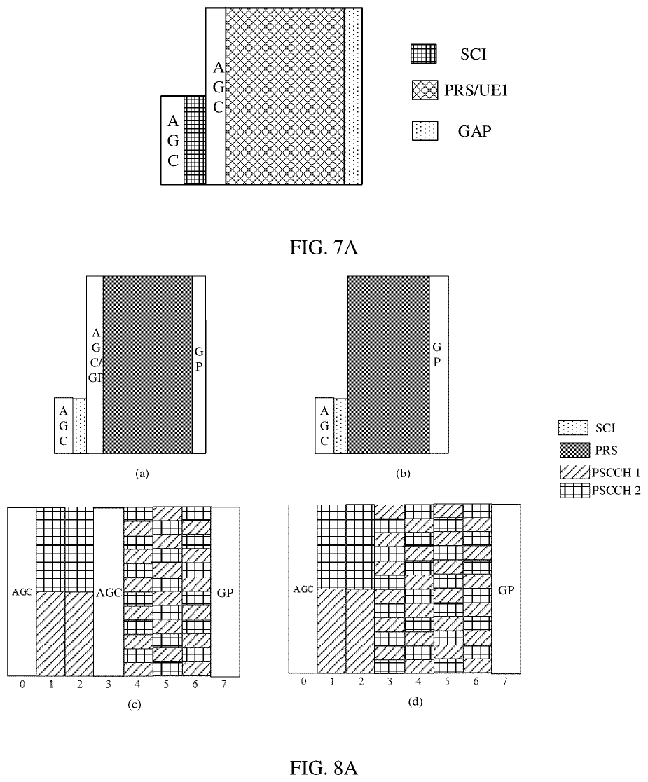

Optionally, in this embodiment of this application, as shown in FIG. 7A, in a case that the detection and resource selection of the shared resource pool are determined based on the DMRS of the PSCCH, and that the slot used for transmitting the SL reference signal does not include the PSSCH, the SL reference signal can be mapped to a symbol in which the DMRS of the PSSCH is located.

Optionally, in this embodiment of this application, in the shared resource pool (in a case that an SL-PRS is configured), the signal for expected resource detection is the DMRS of the PSCCH.

It should be noted that for some examples herein, reference may be made to the following implementation 5.

In the mapping resource determining method provided in this embodiment of this application, the UE may determine at least one of the pattern or the starting symbol of the SL reference signal based on the first information, where the first information includes at least one of the following: the total number of symbols used for SL transmission in the slot, the resource indication information of the SL reference signal, the resource pool type information, or the time division multiplexing enable information. Therefore, by designing a resource structure of the SL reference signal, this solution can maximize resource utilization of a resource pool with different symbols. In addition, in the shared resource pool, backward compatibility with R16/R17 UE in the shared resource pool is ensured, and sharing for SL positioning in the shared resource pool for R18 UE can be implemented.

The following describes related examples in a mapping resource determining method in an embodiment of this application by using implementations (implementations 1 to 5). The following implementations are illustrated by using an example in which an SL reference signal is an SL-PRS.

### Implementation 1: Pattern and Time Domain Position of an SL Reference Signal (for Example, Time Domain Symbol and Length of an SL-PRS)

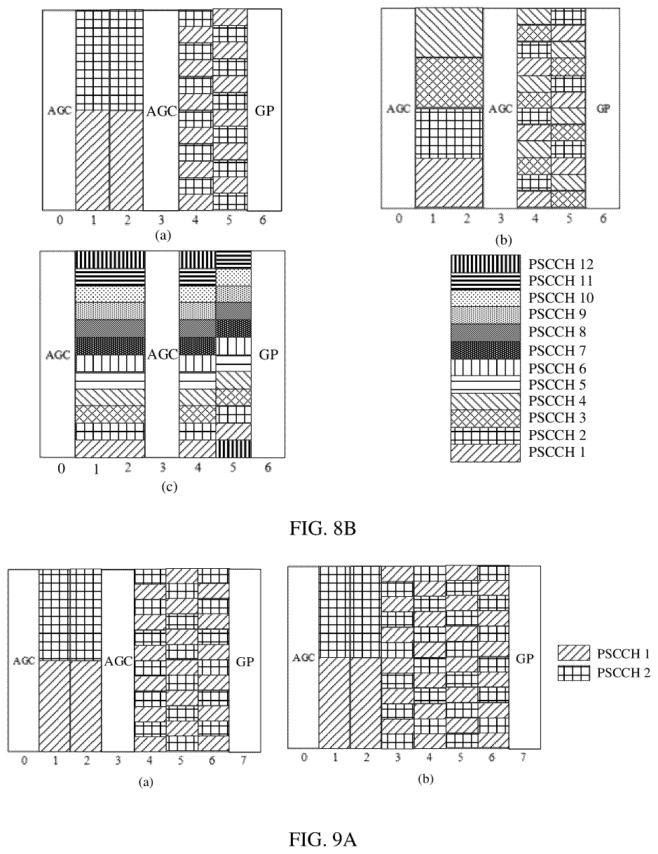

FIG. 8A shows a mapping pattern of a slot for transmitting an SL-PRS. (a) and (b) in FIG. 8A relate to time domain pattern positions, and (c) and (d) in FIG. 8A further include an SL-PRS pattern with a frequency domain comb.

Optionally, a symbol position l̅ of the SL-PRS is determined based on the following Table 2 to Table 5. It should be noted that as long as one cell in the table is used, the current pattern may be considered to fall within the protection scope of this application. An unfilled part of the table is not within the protection scope of this application.

Case 1: Time domain mapping of the SL-PRS based on a plurality of patterns

TABLE 2
SL-PRS time domain position

| l_{d} in | SL-PRS Position | | | | |
|---|---|---|---|---|---|
| symbols | PSCCH duration 2 symbols | | | | |
| for | Number of SL-PRS | | | | |
| SL-PRS | 2 | 3 | 4 | 5 | 6 |

| | | | | |
|---|---|---|---|---|
| 3 | {4, 5} | | | |
| 4 | | {4, 5, 6} | | |
| 5 | | | {4, 5, 6, 7} | |
| 6 | | | | {4, 5, 6, 7, 8} |
| . . . | | | | |

TABLE 3
SL-PRS time domain position

| | SL-PRS Position | | | | |
|---|---|---|---|---|---|
| l_{d} in | PSCCH duration 2 symbols | | | | |
| symbols for | Number of SL-PRS | | | | |
| SL-PRS | 2 | 3 | 4 | 5 | 6 |

| | | | | |
|---|---|---|---|---|
| 3 | {3, 4, 5} | | | |
| 4 | | {3, 4, 5, 6} | | |
| 5 | | | {3, 4, 5, 6, 7} | |
| 6 | | | | {3, 4, 5, 6, 7, 8} |
| . . . | | | | |

TABLE 4
SL-PRS time domain position

| | SL-PRS Position | | | | |
|---|---|---|---|---|---|
| l_{d} in | PSCCH duration 3 symbols | | | | |
| symbols for | Number of SL-PRS | | | | |
| SL-PRS | 1 | 2 | 3 | 4 | 5 |

| | | | | |
|---|---|---|---|---|
| 3 | {5} | | | |
| 4 | | {5, 6} | | |
| 5 | | | {5, 6, 7} | |
| 6 | | | | {5, 6, 7, 8} |
| . . . | | | | |

TABLE 5
SL-PRS time domain position

| | SL-PRS Position | | | | |
|---|---|---|---|---|---|
| l_{d} in | PSCCH duration 3 symbols | | | | |
| symbols for | Number of SL-PRS | | | | |
| SL-PRS | 2 | 3 | 4 | 5 | 6 |

| | | | | |
|---|---|---|---|---|
| 3 | {4, 5} | | | |
| 4 | | {4, 5, 6} | | |
| 5 | | | {4, 5, 6, 7} | |
| 6 | | | | {4, 5, 6, 7, 8} |
| . . . | | | | |

As shown in FIG. 8B, a time domain position of the SL-PRS is shown in a case that time division multiplexing mapping is not enabled (SL-PRS Pattern without TDM).
(1) Assuming that a number of symbols in the slot is 7, time domain positions of the SL-PRS include {2 (the number of symbols of the SL-PRS), 2 (comb size)}, or {2, 4}, or {2, 12}, or {2, 6}, where the PSCCH is located in symbols 1 and 2, and a starting symbol of the SL-PRS is 4.
(2) Assuming that the number of symbols in the slot is 8, time domain positions of the SL-PRS include: {3, 2}, {3, 4}, and {3, 6}, where the PSCCH is located in symbols 1 and 2, and the starting symbol of the SL-PRS is 4; or {4, 2}, {4, 4}, and {4, 12}, or FFS other values {X, 8} and {X, 6}, where the PSCCH is located in symbols 1 and 2, and the starting symbol of the SL-PRS is 3.
(3) Assuming that the number of symbols in the slot is 9, time domain positions of the SL-PRS include: {4, 2}, {4, 4}, {4, 6}, and {4, 12}, where the PSCCH is located in symbols 1 and 2, and the starting symbol of the SL-PRS is 4; or {5, 2}, {5, 4}, and {5, 12}, or an FFS other value {X, 8}, where the PSCCH is located in symbols 1 and 2, and the starting symbol of the SL-PRS is 3.
(4) Assuming that the number of symbols in the slot is 10, time domain positions of the SL-PRS include: {5, 2}, {5, 4}, {5, 6}, and {5, 12}, where the PSCCH is located in symbols 1 and 2, and the starting symbol of the SL-PRS is 4; or {6, 2}, {6,4}, {6,6}, and {6,12}, or an FFS other value {X, 8}, where the PSCCH is located in symbols 1 and 2, and the starting symbol of the SL-PRS is 3.
Case 2: TDM time domain mapping structure of the SL-PRS based on more than N symbols (for example, 10 symbols).

### Implementation 2: Pattern and Time Domain Position of an SL-PRS (for Example, Time Domain Symbol and Length of the SL-PRS)

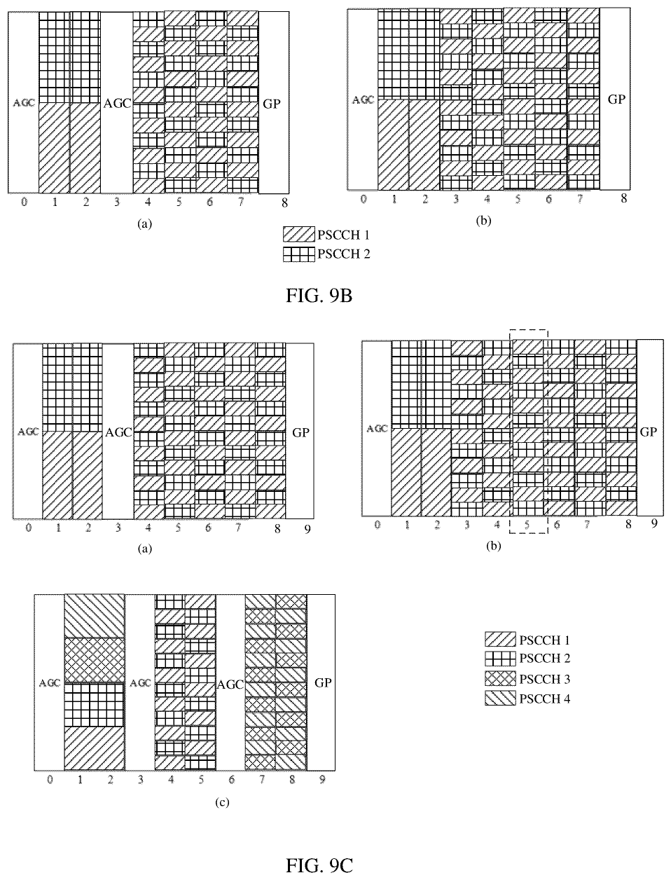

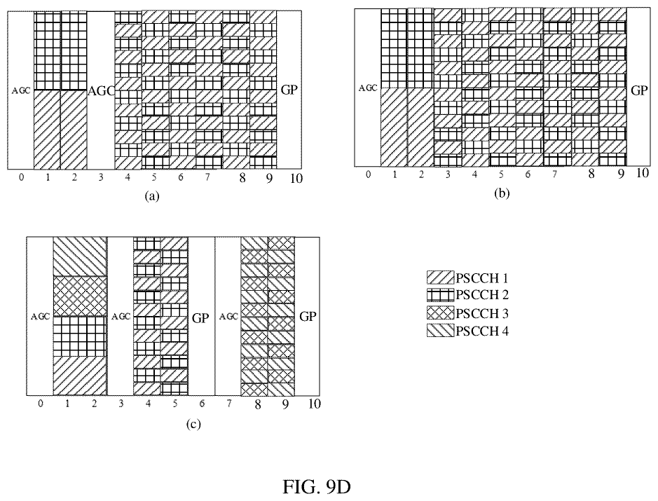

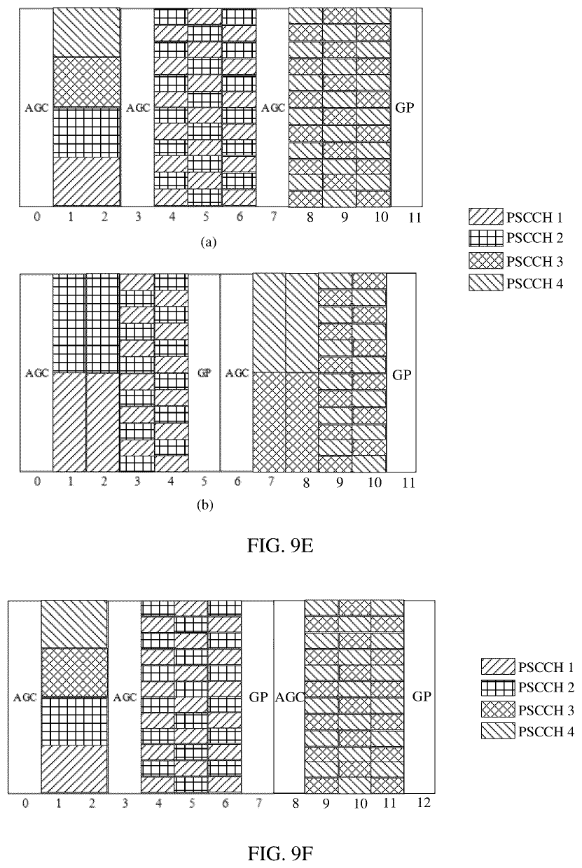

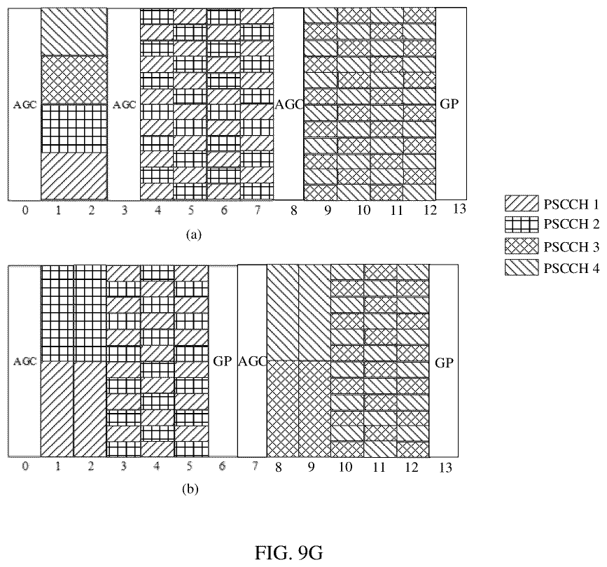

It should be noted that the following SL-PRS structure with 2 symbols or 12 symbols in FIG. 9A to FIG. 9G is used as an example. If a type 1 TDM structure is implemented, a first TDM block has two symbols and a second block has three symbols; or conversely, inconsistency of (N, M) of a TDM structure in a single slot is caused. Assuming that the number of symbols of the SL-PRS is 12, the first type (type 1) is: {2, 2}+{3, 2}, or {3, 4}+{2, 4} (it should be noted that symbol configurations of consecutive symbols are different).

FIG. 9A to FIG. 9G are respectively schematic diagrams of structures of SL-PRSs with 7 to 13 symbols.
a. FIG. 9A is a schematic diagram of a structure (a number of symbols in a slot is 8).
Case 1-1: A number of symbols of a PSCCH is 2, and an SL-PRS is located in fourth, fifth, and sixth symbols or in symbols 3, 4, 5, and 6.
Case 2: A number of symbols of a PSCCH is 2, a DMRS is {1, 5}, an SL-PRS is located in third and fourth symbols, and a PSSCH is located in second and sixth symbols.
b. FIG. 9B is a schematic diagram of a structure (a number of symbols in a slot is 9).
Case 1-1: A number of symbols of a PSCCH is 2, and an SL-PRS is located in fourth, fifth, sixth, and seventh symbols or in symbols 3, 4, 5, 6, and 7.
c. FIG. 9C is a schematic diagram of a structure (a number of symbols in a slot is 10).
Case 1: A number of symbols in a slot in which an SL-PRS is located is 9, a PSCCH occupies two symbols, and the SL-PRS is located in fourth, fifth, sixth, seventh, and eighth symbols or in symbols 3, 4, 5, 6, 7, and 8.
d. FIG. 9D is a schematic diagram of a structure (a number of symbols in a slot is 11).
Case 1: A number of symbols of a PSCCH is 2, and an SL-PRS is located in fourth, fifth, sixth, seventh, eighth, and ninth symbols or in symbols 3, 4, 5, 6, 7, 8, and 9.
e. FIG. 9E is a schematic diagram of a structure (a number of symbols in a slot is 12).
Case 1: As shown in (a) in FIG. 9E, a number of symbols of a PSCCH is 2, and an SL-PRS is located in fourth, fifth, sixth, eighth, ninth, and tenth symbols.
Case 2: As shown in (b) in FIG. 9E, a number of symbols of a PSCCH is 4, and an SL-PRS is located in third, fourth, ninth, and tenth symbols.
f. FIG. 9F is a schematic diagram of a structure (a number of symbols in a slot is 13).
Case 1: A number of symbols of a PSCCH is 2, and an SL-PRS is located in fourth, fifth, and sixth symbols or in symbols 9, 10, and 11.
g. FIG. 9G is a schematic diagram of a structure (a number of symbols in a slot is 14), showing the foregoing second type and third type separately:
Case 1: As shown in (a) in FIG. 9G, a PSCCH occupies two symbols, which are a symbol 1 and a symbol 2; optionally, two SL-PRS starting symbols are a symbol 4 and a symbol 9; there are two candidate SL-PRS time domain mapping patterns; an SL-PRS time domain mapping pattern 1 is located in fourth, fifth, sixth, and seventh symbols, where a number M of symbols is 4; and an SL-PRS time domain mapping pattern 2 is located in symbols 9, 10, 11, and 12, where a number M of symbols is 4. In the example, a comb size is 2. The candidate SL-PRS mapping patterns in this example have same {M, N}, where M is a number of SL-PRS symbols, and N is a comb size of the SL-PRS. A number of candidate SL-PRS mapping patterns in this example is 4. The four candidate SL-PRS mapping patterns correspond to {time domain symbol 4, RE offset 0}, {time domain symbol 4, RE offset 1}, {time domain symbol 9, RE offset 0}, {time domain symbol 9, RE offset 1} respectively. The comb size in this example should be understood as an example. Optionally, N may take any one of the following values: {4, 8, 6, 12}.
Case 1: As shown in (b) in FIG. 9G, a number of symbols of an SL-PRS is 13, a number of symbols of a PSCCH is 4, and the SL-PRS is located in third, fourth, fifth, tenth, eleventh, and twelfth symbols. In this example, two mini-slots are included, and each slot includes seven symbols. A mini-slot 1 is symbols 0-6, and a mini-slot 2 is symbols 1-14. First and second symbols of the mini-slot are symbol positions of the PSCCH. The third to fifth symbols of the mini-slot are symbol positions of the SL-PRS, and a starting symbol of the SL-PRS is the third symbol of the mini-slot. Alternatively, a starting symbol of the SL-PRS is the fourth symbol of the mini-slot.

### Implementation 3: Pattern and Time Domain Position of an SL-PRS (for Example, Time Domain Symbol and Length of the SL-PRS)

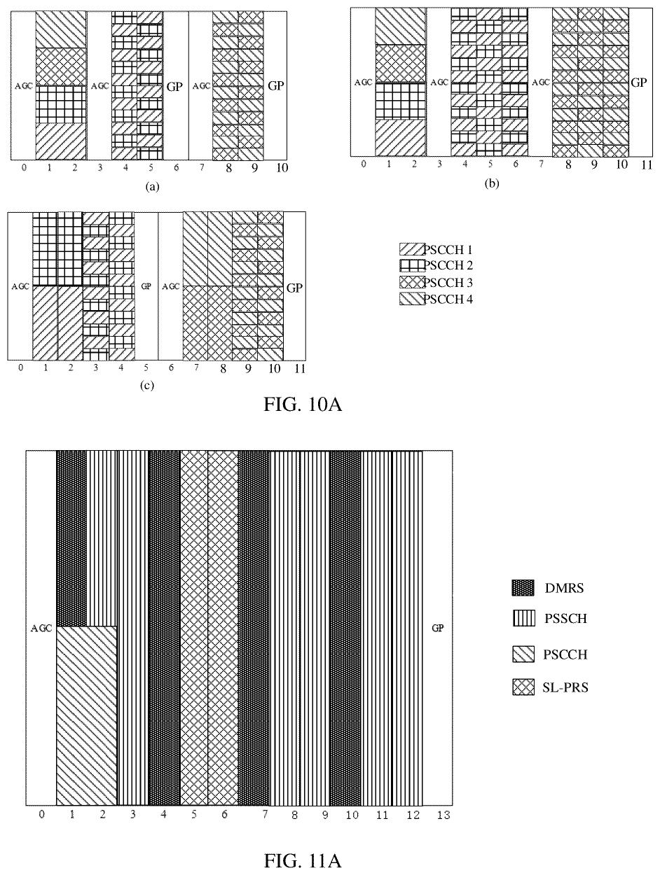

It should be noted that, using the following structure of an SL-PRS with 2 symbols or 12 symbols in FIG. 10A as an example, different time domain mapping patterns are used for odd and even symbols, so that a number of symbols and a comb size of an SL-PRS pattern are the same.

FIG. 10A is a schematic diagram illustrating structures of a TDM type 1 (the foregoing first type), a TDM type 2-1 (the foregoing second type), and a TDM type 2-2 (the foregoing third type).

Optionally, odd symbols use a pattern 1, with a PSCCH mapped at the beginning. Even symbols use a pattern 2, that is, a mini-slot pattern, or pattern mapping with only one GP.

It should be noted that the foregoing example is a comb 2, which may be extended to a comb 4, 6, or 8.

### Implementation 4: A Shared Resource Pool Includes Patterns and Time Domain Positions of a PSCCH, a PSSCH, and an SL-PRS (for Example, Time Domain Symbol and Length of the SL-PRS)

4-1. As shown in FIG. 11A, using 14 symbols as an example, same as case 3 of the following implementation 5, comb-based multiplexing mapping is not supported.
4-2. As shown in FIG. 11B, using 14 symbols as an example, comb-based multiplexing mapping is supported, and a PSSCH (including at least second-stage SCI) is included as follows:
1. A bandwidth of an SL-PRS is larger than a bandwidth of UE for actually transmitting a PSCCH and a PSSCH; and
   comb-based multiplexing is used for a multi-user SL-PRS, that is, different UEs are mapped to different RE offsets.
2. The PSSCH and the PSCCH have a same bandwidth or frequency domain position, to avoid uncertainty of PSSCH data positions in comb-based multi-user multiplexing. As shown in FIG. 11B, symbols 1 and 2 are time domain positions of the PSCCH, and symbols 4, 5, 11, and 12 may be used to map the PSSCH. Multiple users occupy one or more different subchannels on a same symbol. Same padding represents a user.
3. A multi-user PSCCH is multiplexed by FDM, or a multi-user PSSCH is multiplexed by FDM; and
the PSSCH and the PSCCH have a same bandwidth or frequency domain position, to avoid uncertainty of PSSCH data positions in comb-based multi-user multiplexing.
4. The SL-PRS is mapped to fixed symbols, and the PSSCH excludes symbols of the SL-PRS for TBS calculation and time-frequency resource mapping.
5. If a resource with a low PSCCH frequency domain position among candidate resources can be scheduled, the resource is preferentially selected. In other words, a resource with an RE offset 0 is preferentially selected.

### Implementation 5: Shared Resource Pool

Case 1: As configured in Table 6, a shared resource pool is detected based on a DMRS of a PSCCH, and an SL-PRS configuration ignores a position of a DMRS of a PSSCH for mapping. Optionally, a symbol of an SL-PRS is related to a number of symbols in a slot and a number of symbols of the PSCCH, such as ld-3 (that is, available symbol 3 to ld-1) or ld-4 (that is, available symbol 4 to ld-1). It should be noted that if a cell in the table corresponds to this case, this case shall fall within the protection scope of the present application.

TABLE 6

| l_{d} in | SL-PRS Position | | | | | | | |
|---|---|---|---|---|---|---|---|---|
| symbols | PSCCH duration 2 symbols | | | | | | | |
| for | Number of SL-PRS | | | | | | | |
| SL-PRS | 4 | 5 | 6 | 7 | 8 | 9 | 10 | 11 |
| 6 | {3, 4, 5} | | | | | | | |
| 7 | | {3, 4, 5, | | | | | | |
| | | 6} | | | | | | |
| 8 | | | {3, 4, 5, 6, | | | | | |
| | | | 7} | | | | | |
| 9 | {4, 5, 6, | | | {3, 4, | | | | |
| | 7} | | | 5, 6, 7, | | | | |
| | | | | 8} | | | | |
| 10 | {4, 5, 6, | | | | {3, 4, 5, | | | |
| | 7} | | | | 6, 7, 8, | | | |
| | | | | | 9} | | | |
| 11 | | | {4, 5, 6, 7, | | | {3, 4, 5, | | |
| | | | 8, 9} | | | 6, 7, 8, 9, | | |
| | | | | | | 10} | | |
| 12 | | | {4, 5, 6, 7, | | | | {3, 4, 5, 6, | |
| | | | 8, 9] | | | | 7, 8, 9, 10, | |
| | | | | | | | 11} | |
| 13 | | | {4, 5, 6, 7, | | | | | {3, 4, 5, 6, |
| | | | 8, 9} | | | | | 7, 8, 9, 10, |
| | | | | | | | | 12} |

Case 2: A shared resource pool is detected based on a DMRS of a PSSCH, and an SL-PRS configuration should exclude a position of the DMRS of the PSSCH for mapping.

Optionally, a DMRS pattern is {3, 8}, and optional symbols used for an SL-PRS are {4, 5, 6, 7}. Optionally, a DMRS pattern is {3, 10}, and optional symbols used for an SL-PRS are {4, 5, 6, 7, 8, 9}.
Case 3-1: A shared resource pool is detected based on a DMRS of a PSSCH, and an SL-PRS configuration excludes a position of the DMRS of the PSSCH for mapping. Optionally, symbols of a DMRS pattern include {1}. For example, the pattern is {1, 5}, {1, 4, 7}, {1, 4, 7, 10}, or {1, 5, 9}. Optionally, a slot with this pattern cannot be used for SL-PRS transmission, or an SL-PRS is not expected to be associated with the DMRS pattern including a symbol 1 in first-stage SCI.

Optionally, a transmission bandwidth of the SL-PRS is the same as that of the PSSCH, and reuse of same time-frequency resources with other UE is not expected.
Case 1: As configured in Table 7A and Table 7B, a shared resource pool is detected based on a DMRS of a PSCCH, and an SL-PRS configuration ignores a position of a DMRS of a PSSCH for mapping. Optionally, a symbol of an SL-PRS is related to a number of symbols in a slot and a number of symbols of the PSCCH, such as ld-3 (that is, available symbol 4 to ld-1) or ld-4 (that is, available symbol 5 to ld-1).

TABLE 7A

| l_{d} in | SL-PRS Position | | | | | | | |
|---|---|---|---|---|---|---|---|---|
| symbols | PSCCH duration 3 symbols | | | | | | | |
| for | Number of SL-PRS | | | | | | | |
| SL-PRS | 3 | 4 | 5 | 6 | 7 | 8 | 9 | 10 |
| 6 | {45} | | | | | | | |
| 7 | | {456} | | | | | | |
| 8 | | | {4567} | | | | | |
| 9 | {5, 6, | | | {45678} | | | | |
| | 7} | | | | | | | |
| 10 | {5, 6, | | | | {456789} | | | |
| | 7} | | | | | | | |
| 11 | | | {5, 6, 7, 8, | | | {45678910} | | |
| | | | 9} | | | | | |
| 12 | | | {5, 6, 7, 8, | | | | {4567891011} | |
| | | | 9] | | | | | |
| 13 | | | {5, 6, 7, 8, | | | | | {4567891012} |
| | | | 9} | | | | | |

TABLE 7B

| | DMRS position l̅ | | | | | |
|---|---|---|---|---|---|---|
| l_{d} in | PSCCH duration 2 symbols | | | PSCCH duration 3 symbols | | |
| sym- | Number of PSSCH DMRS | | | Number of PSSCH DMRS | | |
| bols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

Case 2: A shared resource pool is detected based on a DMRS of a PSSCH, and an SL-PRS configuration should exclude a position of the DMRS of the PSSCH for mapping. Optionally, a DMRS pattern is {4, 8}, and optional symbols used for an SL-PRS are {5, 6, 7}. Optionally, a DMRS pattern is {4, 10}, and optional symbols used for an SL-PRS are {5, 6, 7, 8, 9}.
Case 3-1: A shared resource pool is detected based on a DMRS of a PSSCH, and an SL-PRS configuration excludes a position of the DMRS of the PSSCH for mapping. Optionally, symbols of a DMRS pattern include {1}. For example, the pattern is {1, 5}, {1, 4, 7}, {1, 4, 7, 10}, or {1, 5, 9}. Optionally, a slot with this pattern cannot be used for SL-PRS transmission (or an SL-PRS is not expected to be associated with the DMRS pattern including a symbol 1 in first-stage SCI).

Optionally, a transmission bandwidth of the SL-PRS is the same as that of the PSSCH, and reuse of same time-frequency resources with other UE is not expected.

It should be noted that this implementation is an illustration of a comb, and that similar comb 2, comb 4, comb 6, and comb 8 may be inferred with reference to the foregoing implementation 1.

### 1. A Number of Symbols of an SL-PRS is 6 (or a Number of Symbols in a Slot is 7)

Case 1-1: As shown in FIG. 12A, a number of symbols of an SL-PRS is 6 or a number of symbols in a slot is 7, a number of symbols of a PSCCH is 2, a symbol of a DMRS of a PSSCH is ignored (that is, the SL-PRS may be mapped to the symbol of the DMRS of the PSSCH), and the SL-PRS is located in fourth and fifth symbols or in symbols 3, 4, and 5.
Case 3: As shown in FIG. 12B, a number of symbols of an SL-PRS is 6 or a number of symbols in a slot is 7, a number of symbols of a PSCCH is 2, symbols of a DMRS of a PSSCH are {1, 5}, the SL-PRS is located in third and fourth symbols, and the PSSCH is located in a second symbol. In this embodiment, the SL-PRS is not mapped to a DMRS symbol.

Case 4: As shown in FIG. 12C, a number of symbols of an SL-PRS is 6 or a number of symbols in a slot is 7, a number of symbols of a PSCCH is 2, symbols of a DMRS of a PSSCH are {1, 5}, the SL-PRS is located in third and fourth symbols, and the SL-PRS is not mapped to a first symbol of the DMRS of the PSSCH. The PSSCH is located in the fourth symbol and has a same bandwidth or frequency domain position as the PSCCH.

### 2. A number of Symbols of an SL-PRS is 7 (or a Number of Symbols in a Slot is 8)

Case 1-1: As shown in FIG. 13A, a number of symbols of an SL-PRS is 7 or a number of symbols in a slot is 8, a number of symbols of a PSCCH is 2, a symbol of a DMRS of a PSSCH is ignored (that is, the SL-PRS may be mapped to the symbol of the DMRS of the PSSCH), and the SL-PRS is located in fourth, fifth, and sixth symbols or in symbols 3, 4, 5, and 6.
Case 3: As shown in FIG. 13B, a number of symbols of an SL-PRS is 7 or a number of symbols in a slot is 8, a number of symbols of a PSCCH is 2, symbols of a DMRS are {1, 5}, the SL-PRS is located in third and fourth symbols, and a PSSCH is located in second and sixth symbols. In this embodiment, the SL-PRS is not mapped to a DMRS symbol.

### 3. A Number of Symbols of an SL-PRS is 8 (or a Number of Symbols in a Slot is 9)

Case 1-1: As shown in FIG. 14A, a number of symbols of an SL-PRS is 8 or a number of symbols in a slot is 9, a number of symbols of a PSCCH is 2, a symbol of a DMRS of a PSSCH is ignored (that is, the SL-PRS may be mapped to the symbol of the DMRS of the PSSCH), and the SL-PRS is located in fourth, fifth, sixth, and seventh symbols or in symbols 3, 4, 5, 6, and 7.
Case 3: As shown in FIG. 14B, a number of symbols of an SL-PRS is 7 or a number of symbols in a slot is 9, a number of symbols of a PSCCH is 2, symbols of a DMRS are {1, 5}, the SL-PRS is located in third and fourth symbols, and a PSSCH is located in second, sixth, and seventh symbols. In this embodiment, the SL-PRS is not mapped to a DMRS symbol.
Case 4-1: As shown in FIG. 14C, a number of symbols of an SL-PRS is 8 or a number of symbols in a slot is 9, a number of symbols of a PSCCH is 2, symbols of a DMRS are {1, 5}, and the SL-PRS is located in a fourth symbol or a seventh symbol.

Optionally, in an embodiment, there is only one consecutive symbol for SL-PRS transmission, that is, the fourth symbol or the seventh symbol.

Optionally, in another embodiment, a plurality of SL-PRS patterns are configured in a shared resource pool, and the SL-PRS patterns include a plurality of SL-PRS time domain patterns. For example, a starting symbol of a pattern is a first or second symbol {symbol 6 or symbol 7} after a DMRS, and that of another SL-PRS pattern is {third or fourth symbol}.
Case 4-2: As shown in FIG. 14D, a number of symbols of an SL-PRS is 8 or a number of symbols in a slot is 9, a number of symbols of a PSCCH is 2, and symbols of a DMRS are {1, 5}. The SL-PRS includes two time domain candidate positions. For example, a time domain candidate position 1 is located in third and fourth symbols, and a time domain candidate position 2 is located in symbols 6 and 7.
Case 4-3: As shown in FIG. 14E, a number of symbols of an SL-PRS is 8 or a number of symbols in a slot is 9, a number of symbols of a PSCCH is 2, symbols of a DMRS are {1, 5}, and the SL-PRS is located in at least one of symbols 6 or 7. Optionally, a PSSCH is mapped to a symbol X.

### 4. A Number of Symbols of an SL-PRS is 9 (or a Number of Symbols in a Slot is 10)

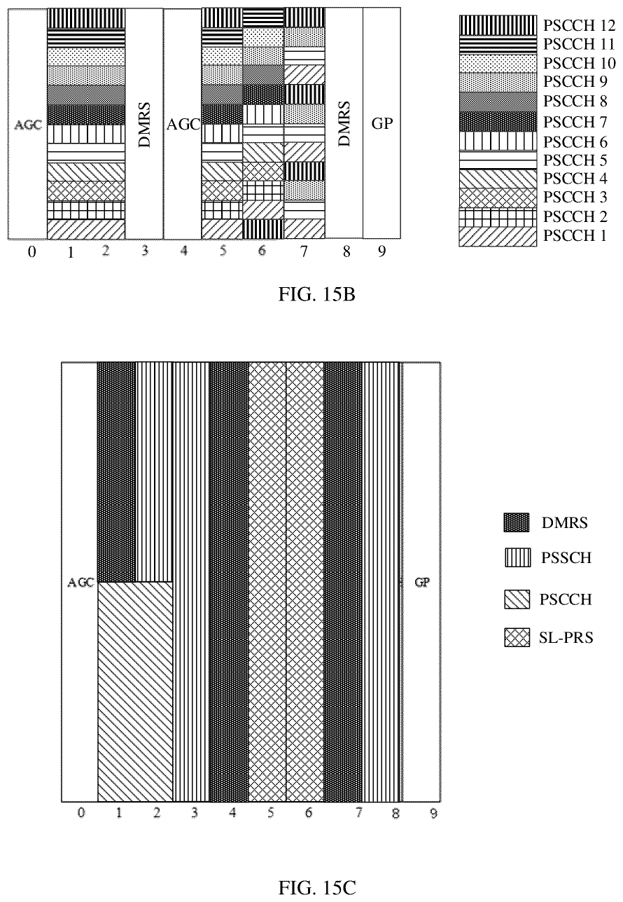

Case 1: As shown in FIG. 15A, a number of symbols of an SL-PRS is 9 or a number of symbols in a slot is 10, a number of symbols of a PSCCH is 2, a symbol of a DMRS of a PSSCH is ignored (that is, the SL-PRS may be mapped to the symbol of the DMRS of the PSSCH), and the SL-PRS is located in fourth, fifth, sixth, seventh, and eighth symbols or in symbols 3, 4, 5, 6, 7, and 8.
Case 2: As shown in FIG. 15B, a DMRS pattern {3, 8} is used, where symbols 3 and 8 are avoided, and symbols 4, 5, 6, and 7 are used for SL-PRS transmission. Alternatively, an SL-PRS is located in fifth, sixth, and seventh symbols. Optionally, a PSSCH is located in the fifth, sixth, and seventh symbols, and is located in different symbols from the SL-PRS, and has a same bandwidth or frequency domain position as a PSCCH.
Case 3: As shown in FIG. 15C, a DMRS pattern {1, 4, 7} is used, where symbols 1, 4, and 7 are avoided, and symbols 5 and 6 are used for SL-PRS transmission.

### 5. A Number of Symbols of an SL-PRS is 10 (or a Number of Symbols in a Slot is 11)

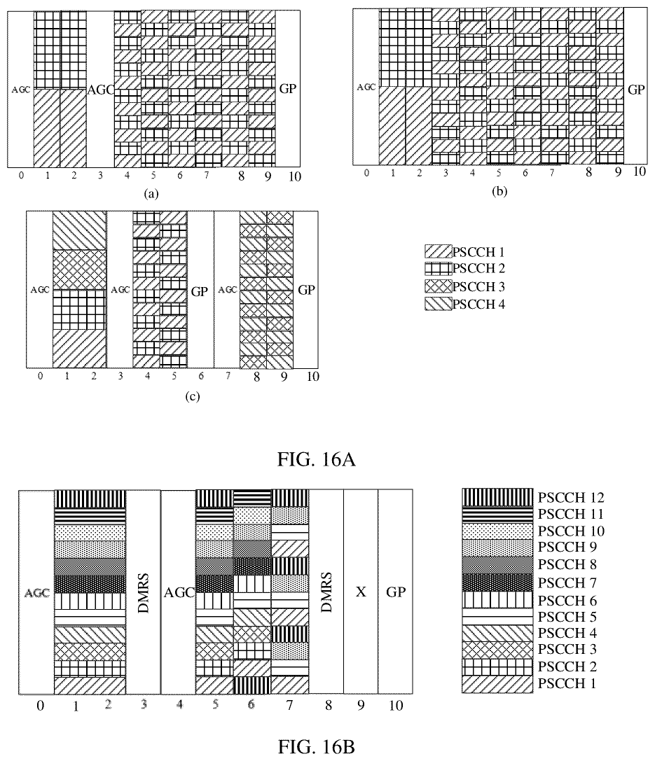

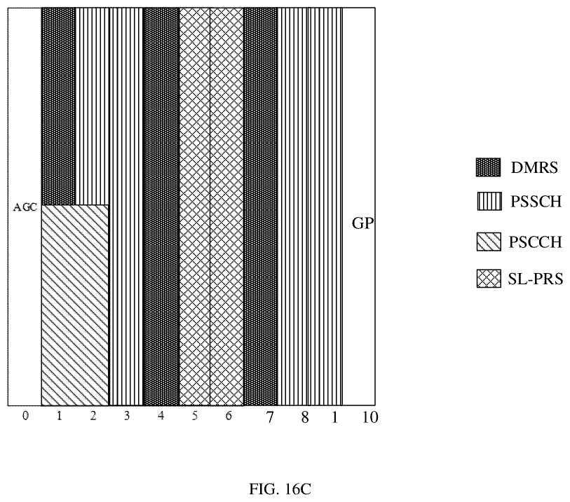

Case 1-3: As shown in FIG. 16A, it is consistent with the first type (type 1) in the foregoing embodiment.
Case 2: As shown in FIG. 16B, a DMRS pattern {3, 8} is used, where symbols 3 and 8 are avoided, and symbols 4, 5, 6, and 7 are used for SL-PRS transmission (in an optional embodiment, a symbol X is used for transmitting a PSSCH, or is not used). Alternatively, an SL-PRS is located in fifth, sixth, and seventh symbols. Optionally, the PSSCH is located in the fifth, sixth, and seventh symbols, or the symbol X, and does not overlap with the symbol of the SL-PRS, and has a same bandwidth or frequency domain position as a PSCCH.

Optionally, a DMRS pattern {1, 4, 7} is used, where symbols 1, 4, and 7 are avoided, and symbols 5 and 6 are used.
Case 3: As shown in FIG. 16C, a DMRS pattern {1, 4, 7} is used, where symbols 1, 4, and 7 are avoided, and symbols 5 and 6 are used.

### 6. A Number of Symbols of an SL-PRS is 11 (or a Number of Symbols in a Slot is 12)

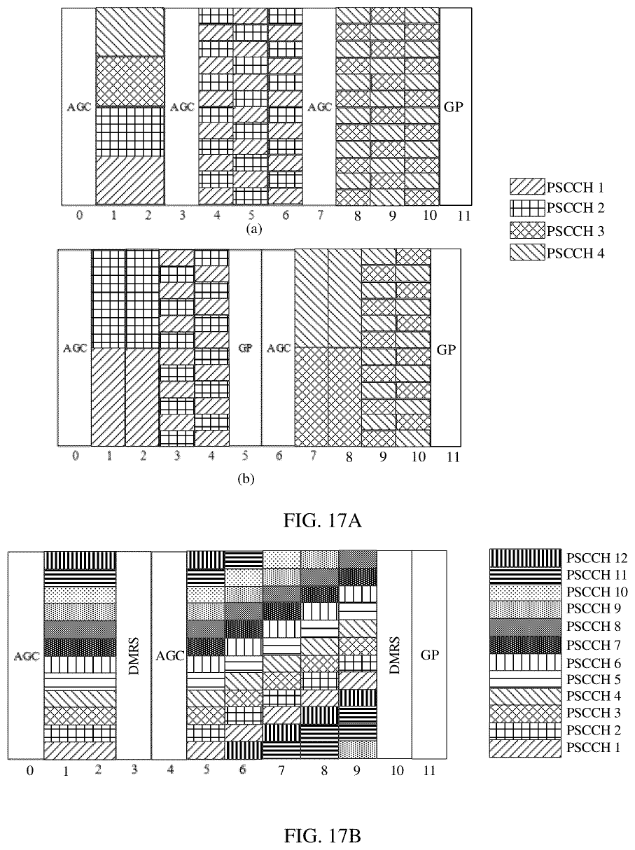

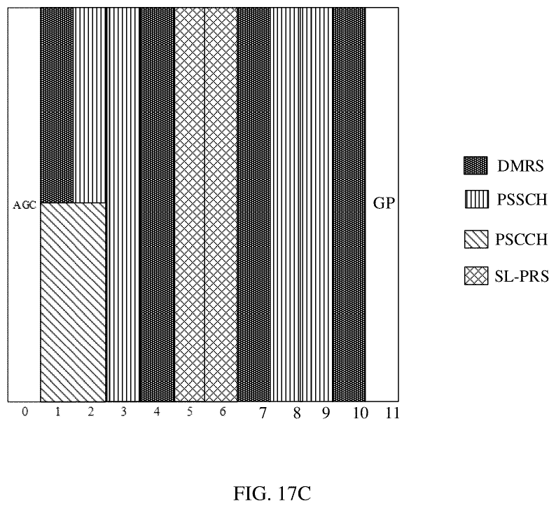

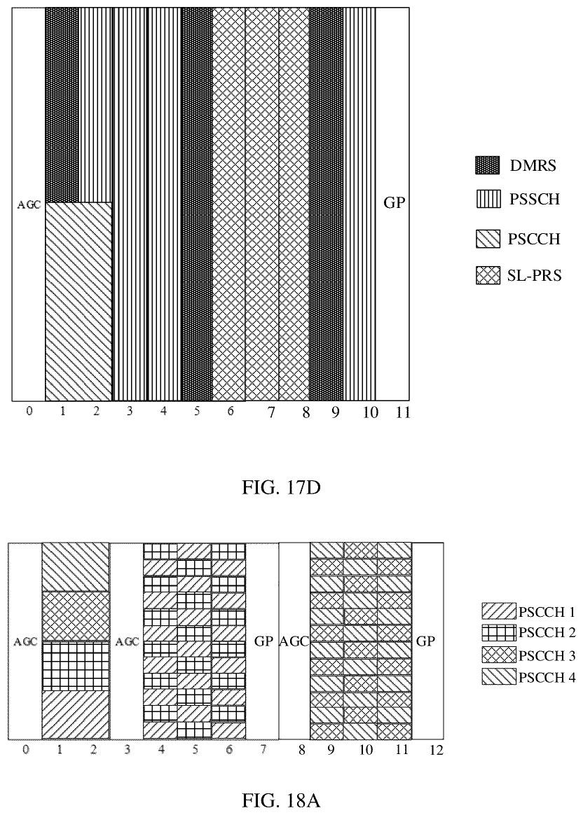

Case 1: As shown in FIG. 17A, two time domain patterns may be combined with those in a case that a total number of symbols is greater than N.
Case 2: As shown in FIG. 17B, a DMRS pattern {3, 10} is used, where symbols 3 and 10 are avoided, and symbols 4, 5, 6, 7, 8, and 9 are used for SL-PRS transmission. Alternatively, an SL-PRS is located in fifth, sixth, seventh, eighth, and ninth symbols. Optionally, a PSSCH is located in the fifth, sixth, seventh, eighth, and ninth symbols, or a symbol X, and does not overlap with the symbol of the SL-PRS, and has a same bandwidth or frequency domain position as a PSCCH.
Case 3-1: As shown in FIG. 17C, a DMRS pattern {1, 4, 7, 10} is used, where symbols 1, 4, 7, and 10 are avoided, and symbols 5 and 6 are used for sending an SL-PRS.
Case 3-2: As shown in FIG. 17D, a DMRS pattern {1, 5, 9} is used, where symbols 1, 5, and 9 are avoided, and symbols 6, 7, and 8 are used for sending an SL-PRS.

### 7. A Number of Symbols of an SL-PRS is 12 (or a Number of Symbols in a Slot is 13)

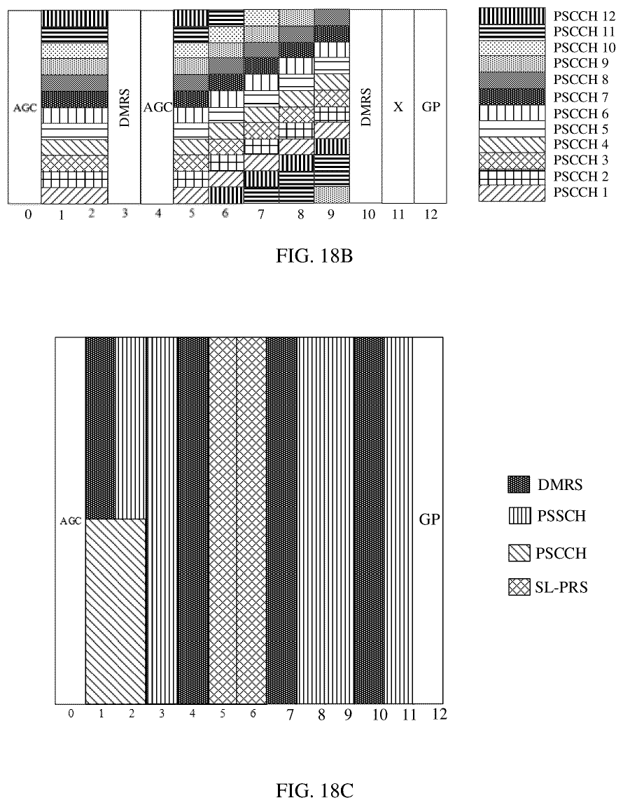

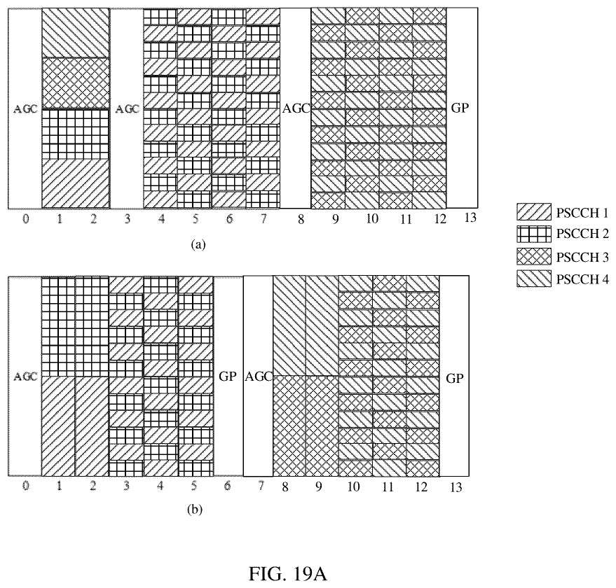

Case 1: As shown in FIG. 18A, two time domain patterns may be combined with those in a case that a total number of symbols is greater than N.
Case 2: As shown in FIG. 18B, a DMRS pattern {3, 10} is used, where symbols 3 and 10 are avoided, and symbols 4, 5, 6, 7, 8, and 9 are used for SL-PRS transmission (a symbol X is not transmitted, or is used for transmitting a PSSCH). Alternatively, an SL-PRS is located in fifth, sixth, seventh, eighth, and ninth symbols. Optionally, the PSSCH is located in the fifth, sixth, seventh, eighth, and ninth symbols, or the symbol X, and does not overlap with the symbol of the SL-PRS, and has a same bandwidth or frequency domain position as a PSCCH.
Case 3-1: As shown in FIG. 18C, a DMRS pattern {1, 4, 7, 10} is used, where symbols 1, 4, 7, and 10 are avoided, and symbols 5 and 6 are used for sending an SL-PRS.
Case 3-2: A DMRS pattern {1, 5, 9} is used, where symbols 1, 5, and 9 are avoided, and symbols 6, 7, and 8 are used for sending an SL-PRS.

### 8. A Number of Symbols of an SL-PRS is 13 (or a Number of Symbols in a Slot is 14)

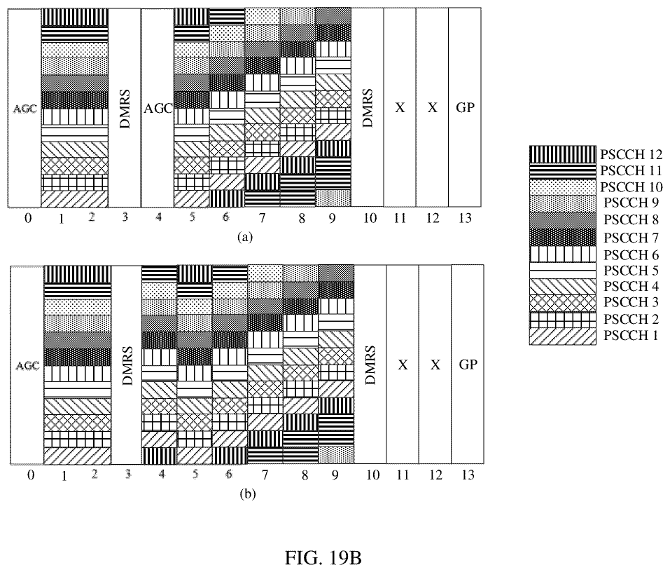

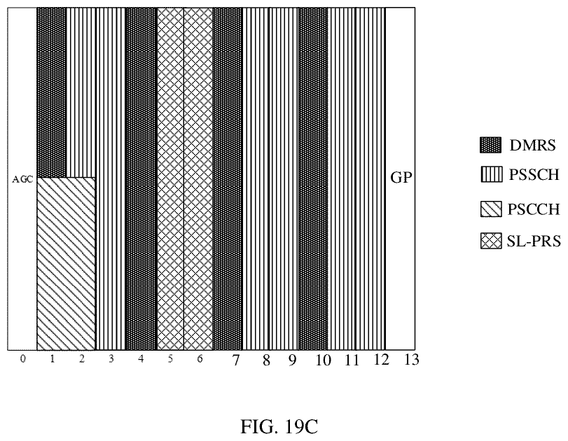

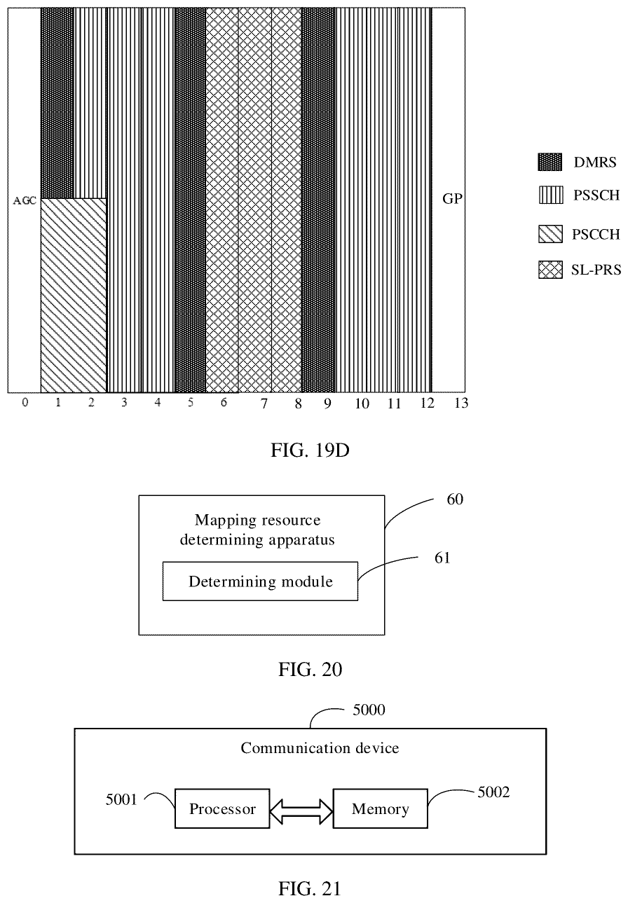

Case 1: FIG. 19A is a schematic diagram illustrating patterns of the foregoing second type and third type respectively. Two time domain patterns may be combined with those in a case that a total number of symbols is greater than N.
Case 2: As shown in FIG. 19B, a DMRS pattern {3, 10} is used, where symbols 3 and 10 of a DMRS are avoided in mapping symbols of an SL-PRS, and symbols 4, 5, 6, 7, 8, and 9 are used for SL-PRS transmission (a symbol X is not transmitted, or is used for transmitting a PSSCH). Alternatively, the SL-PRS is located in fourth, fifth, sixth, seventh, eighth, and ninth symbols. Optionally, the PSSCH is located in one or more of the fifth, sixth, seventh, eighth, and ninth symbols, or the symbol X, and does not overlap with the symbol of the SL-PRS, and has a same bandwidth or frequency domain position as a PSCCH.

Optionally, a symbol 4 may be an AGC symbol ((a) in FIG. 19B) or a symbol of the SL-PRS ((b) in FIG. 19B).
Case 3-1: As shown in FIG. 19C, a DMRS pattern {1, 4, 7, 10} is used, where symbols 1, 4, 7, and 10 are avoided in mapping symbols of an SL-PRS, and symbols 5 and 6 are used for sending the SL-PRS. Remaining symbols may be used to transmit a PSSCH. If there is no corresponding data transmission, data may not be sent.
Case 3-2: As shown in FIG. 19D, a DMRS pattern {1, 5, 9} is used, where symbols 1, 5, and 9 are avoided in mapping symbols of an SL-PRS, and symbols 6, 7, and 8 are used for sending the SL-PRS. Remaining symbols may be used to transmit a PSSCH. If there is no corresponding data transmission, data may not be sent.

Optionally, as shown in Table 8A and Table 8B, a shared resource pool is detected based on a DMRS of a PSCCH, and an SL-PRS configuration ignores a position of a DMRS of a PSSCH for mapping. A symbol of an SL-PRS is related to a number of symbols in a slot and a number of symbols of the PSCCH, such as ld-3 (that is, available symbol 4 to ld-1) or ld-4 (that is, available symbol 5 to ld-1).

TABLE 8A
SL-PRS time domain position

| | SL-PRS position l̅ | | | | | |
|---|---|---|---|---|---|---|
| l_{d} in | PSCCH duration 2 symbols | | | PSCCH duration 3 symbols | | |
| sym- | Number of PSSCH DMRS | | | Number of PSSCH DMRS | | |
| bols | 1 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

TABLE 8B
SL-PRS time domain position

| | SL-PRS Position | | | | |
|---|---|---|---|---|---|
| l_{d} in | PSCCH duration 2 symbols | | | | |
| symbols for | Number of SL-PRS | | | | |
| SL-PRS | 2 | 3 | 4 | 5 | 6 |

| | | | |
|---|---|---|---|
| 6 | {3, 4} | | |
| 7 | {3, 4} | | |
| 8 | {3, 4}, {6, 7} | | |
| 9 | {5, 6} | {4, 5, 6, 7} | |
| 10 | {5, 6} | {4, 5, 6, 7} | |
| 11 | | | {4, 5, 6, 7, 8, 9] |
| 12 | | | {4, 5, 6, 7, 8, 9] |
| 13 | | | {4, 5, 6, 7, 8, 9} |

The mapping resource determining method provided in the embodiments of this application may be performed by a mapping resource determining apparatus. A mapping resource determining apparatus provided in the embodiments of this application is described by assuming that the mapping resource determining method in the embodiments of this application is performed by the mapping resource determining apparatus.

FIG. 20 is a schematic diagram of a possible structure of a mapping resource determining apparatus according to an embodiment of this application. As shown in FIG. 20, the mapping resource determining apparatus 60 may include a determining module 61.

The determining module 61 is configured to determine at least one of a pattern or a starting symbol of an SL reference signal based on first information, where the first information includes at least one of the following: a total number of symbols used for SL transmission in a slot, resource indication information of the SL reference signal, resource pool type information, or time division multiplexing enable information; the time division multiplexing enable information represents that a slot includes at least two time domain candidate positions or at least two candidate time domain mapping patterns; and the resource pool type information represents a dedicated resource pool or a shared resource pool used for transmitting the SL reference signal.

According to the mapping resource determining apparatus provided in this embodiment of this application, the mapping resource determining apparatus may determine at least one of the pattern or the starting symbol of the SL reference signal based on the first information, where the first information includes at least one of the following: the total number of symbols used for SL transmission in the slot, the resource indication information of the SL reference signal, the resource pool type information, or the time division multiplexing enable information. Therefore, by designing a resource structure of the SL reference signal, this solution can maximize resource utilization of a resource pool with different symbols. In addition, in the shared resource pool, backward compatibility with R16/R17 UE in the shared resource pool is ensured, and sharing for SL positioning in the shared resource pool for R18 UE can be implemented.

In a possible implementation, in a case that the total number of symbols is greater than N, the slot includes at least two time domain candidate positions of SL reference signals, and N is an integer greater than or equal to 7.

In a possible implementation, the determining module 61 is configured to perform at least one of the following:
determining a time domain mapping pattern of a control channel and the SL reference signal in the slot based on the first information;
determining a frequency domain mapping pattern of a control channel and the SL reference signal in the slot based on the first information; or
determining a mapping relationship between patterns of a control channel and the SL reference signal in the slot based on the first information.

In a possible implementation, the time domain mapping pattern of the control channel and the SL reference signal in the slot includes at least one of the following time domain mapping patterns: a first type of time domain mapping pattern; a second type of time domain mapping pattern; or a third type of time domain mapping pattern, where
the first type includes a time domain position of a control channel with N1 symbols and at least two time domain positions of SL reference signals, where the control channel with N1 symbols is mapped to first N1 symbols in the slot, a guard period GP symbol exists between the at least two time domain positions of the SL reference signals, and N1 is a positive integer less than or equal to N;
the second type includes a time domain position of a control channel with N1 symbols and at least two time domain positions of SL reference signals, where the control channel with N1 symbols is mapped to first N1 symbols in the slot, no GP symbol exists between the at least two time domain positions of the SL reference signals, and N1 is a positive integer less than or equal to N; and
the third type is that the slot is divided into two mini-slots, where each mini-slot includes a control channel and an SL reference signal.

In a possible implementation, for odd symbols in the slot, a time domain mapping pattern of the odd symbols is the first type of time domain mapping pattern; or
for even symbols in the slot, a time domain mapping pattern of the even symbols is the second type of time domain mapping pattern; or
for even symbols in the slot, a time domain mapping pattern of the even symbols is the third type of time domain mapping pattern.

In a possible implementation, the at least two time domain candidate positions of the SL reference signals have a same SL reference signal pattern.

In a possible implementation, the SL reference signal pattern includes at least one of the following: a number of symbols of the SL reference signal; a comb size of the SL reference signal; a number of automatic gain control AGC symbols associated with the SL reference signal; a number of GP symbols associated with the SL reference signal; or an association rule between a PSCCH and the SL reference signal.

In a possible implementation, the at least two time domain candidate positions of the SL reference signals have different SL reference signal patterns.

In a possible implementation, the different SL reference signal patterns are that the SL reference signals have different starting symbols and different numbers of symbols.

In a possible implementation, the SL reference signal patterns include at least two SL reference signal patterns, and the at least two SL reference signal patterns are configured in a same resource pool.

In a possible implementation, the at least two SL reference signal patterns include frequency domain mapping patterns, and the frequency domain mapping pattern includes at least one of a comb size or a resource element RE offset.

In a possible implementation, the slot includes multiple frequency domain mapping patterns, and comb sizes of the multiple frequency domain mapping patterns are the same.

In a possible implementation, up to K SL reference signal patterns are included in a same resource pool, K is a maximum number of SL reference signal patterns supported in the same resource pool, and K is an integer greater than 1.

In a possible implementation, each SL reference signal pattern is associated with indication information of an SL reference signal; or
each SL reference signal pattern is associated with an SL reference signal starting symbol of the respective SL reference signal pattern; or
each SL reference signal pattern is associated with an RE offset of the respective SL reference signal pattern; or
each SL reference signal pattern is associated with a number of symbols of the respective SL reference signal pattern.

In a possible implementation, the time domain mapping pattern of the control channel and the SL reference signal in the slot includes a mini-slot structure configuration, where each mini-slot indicates a number of symbols of the mini-slot; or each mini-slot indicates a time domain mapping pattern of a control channel and an SL reference signal in the mini-slot.

In a possible implementation, in a case that the number of symbols of each mini-slot is the same, at least one of a number of symbols or a comb size of the SL reference signal is the same; or in a case that the number of symbols of each mini-slot is different, at least one of a number of symbols of the SL reference signal or a number of symbols of a physical sidelink control channel PSCCH is different.

In a possible implementation, each SL reference signal pattern is associated with mini-slot indication information of the SL reference signal pattern, and the mini-slot indication information is used to indicate that the mini-slot is a first mini-slot or a second mini-slot of the slot.

In a possible implementation, the determining module 61 is configured to: determine indication information of the SL reference signal based on the first information and detection of candidate resources for the SL reference signal, where each SL reference signal pattern is associated with indication information of an SL reference signal; or determine, based on the first information and detection of candidate resources for a PSCCH associated with the SL reference signal, a position of the PSCCH associated with the SL reference signal, to determine at least one of the pattern or the starting symbol of the SL reference signal.

In a possible implementation, after determining the indication information of the SL reference signal based on the first information and detection of the candidate resources for the SL reference signal, the determining module 61 is further configured to determine indication information of sidelink control information SCI, where the SCI includes the indication information of the SL reference signal.

In a possible implementation, after determining the indication information of the SL reference signal based on the first information and detection of the candidate resources for the SL reference signal, the determining module 61 is further configured to determine, based on the indication information of the SL reference signal, a frequency domain position or a time domain position of the PSCCH associated with the SL reference signal.

In a possible implementation, the frequency domain position or the time domain position of the PSCCH includes:
a PSCCH corresponding to i-th indication information of an SL reference signal is located in an i-th PSCCH minimum unit, where i is a positive integer; or
a PSCCH corresponding to i-th indication information of an SL reference signal is located in a mod(i+N1, K1)-th PSCCH minimum unit, where i is a positive integer, K1 is a maximum frequency domain candidate position of the PSCCH, and N1 is a frequency shift parameter of the PSCCH.

In a possible implementation, the frequency domain position or the time domain position of the PSCCH includes:
in a case that the indication information of the SL reference signal is local information in each mini-slot, a PSCCH corresponding to i-th indication information of an SL reference signal is located in an i-th PSCCH minimum unit in a current mini-slot, where i is a positive integer; or
in a case that the indication information of the SL reference signal is local information in each slot, a PSCCH corresponding to i-th indication information of an SL reference signal is located in a mod(i, F)-th PSCCH minimum unit in a current mini-slot, where i is a positive integer, and F is a maximum number of SL reference signals in a mini-slot.

In a possible implementation, a time domain mapping pattern of the SL reference signal is determined based on a protocol or a specified table, where
the table includes at least one of the following: a number of symbols used for SL transmission in the slot, the starting symbol of the SL reference signal, a number of symbols of the SL reference signal, or a number of symbols of a PSCCH.

In a possible implementation, in a case that time division multiplexing mapping is not enabled, the SL reference signal pattern includes only a frequency domain mapping pattern, and the frequency domain mapping pattern is associated with at least one piece of the following information: indication information of the SL reference signal or an RE offset of the SL reference signal pattern.

In a possible implementation, the first information includes at least the resource pool type information, and the resource pool type information represents the shared resource pool used for transmitting the SL reference signal. The determining module 61 is configured to: in a case that the SL reference signal is mapped to the shared resource pool, determine at least one of the pattern or the starting symbol of the SL reference signal based on whether a symbol used for SL transmission in the slot is used for transmission of a physical sidelink shared channel PSSCH.

In a possible implementation, the determining module 61 is configured to: in a case that the symbol used for SL transmission in the slot is used for transmission of the PSSCH, determine a mapping pattern of a control channel, the PSSCH, and the SL reference signal in the slot.

In a possible implementation, the mapping pattern of the SL reference signal in the slot includes a symbol position of the SL reference signal, where the SL reference signal is mapped to M symbols after a first demodulation reference signal DMRS after a PSCCH, where M is a positive integer; or the SL reference signal is mapped to M symbols between a first DMRS and a second DMRS after a PSCCH, where M is a positive integer.

In a possible implementation, in a case that the SL reference signal is mapped to the M symbols between the first DMRS and the second DMRS after the PSCCH, a time domain length and a comb size of the SL reference signal are provided by a resource pool configuration and determined with reference to positions of the DMRSs.

In a possible implementation, a mapping pattern of the control channel and the PSSCH in the slot includes one of the following that: there is symbol overlap between the control channel and the PSSCH in the slot; and there is no symbol overlap between the control channel and the PSSCH in the slot.

In a possible implementation, in a case that there is no symbol overlap between the control channel and the PSSCH in the slot, a bandwidth or a frequency domain position of the PSSCH is the same as that of a PSCCH.

In a possible implementation, in a case that the bandwidth or the frequency domain position of the PSSCH is the same as that of the PSCCH, a multi-user PSCCH can be mapped to a same time domain position but different frequency domain positions, where up to K1 users can be mapped to one slot, and KI is a maximum frequency domain candidate position of the PSCCH.

In a possible implementation, in a case that there is symbol overlap between the control channel and the PSSCH in the slot, a bandwidth or a frequency domain position of the PSSCH is the same as that of the SL reference signal.

In a possible implementation, in a case that the bandwidth or the frequency domain position of the PSSCH is the same as that of the SL reference signal, multi-user multiplexing is not supported within a resource of the SL reference signal.

In a possible implementation, in a case that detection and resource selection of the shared resource pool are determined based on a DMRS of the PSSCH, and that a symbol of the DMRS includes a first symbol, SL reference signal mapping at a comb level is not supported in the slot; or
in a case that detection and resource selection of the shared resource pool are determined based on a DMRS of a PSCCH, frequency division multiplexing FDM SL reference signal mapping at a comb level is supported in the slot.

In a possible implementation, in a case that the detection and resource selection of the shared resource pool are determined based on the DMRS of the PSSCH, FDM SL reference signal transmission at the comb level is not supported in a first resource pool, where the first resource pool is a resource pool in which a number of symbols for the SL reference signal is less than or equal to L, and L is an integer greater than 7.

In a possible implementation, in a case that the detection and resource selection of the shared resource pool are determined based on the DMRS of the PSCCH, and that the slot used for transmitting the SL reference signal does not include the PSSCH, the SL reference signal can be mapped to a symbol in which the DMRS of the PSSCH is located.

The mapping resource determining apparatus provided in this embodiment of this application can implement each process of the foregoing method embodiment, with the same technical effect achieved. To avoid repetition, details are not described herein again.

The mapping resource determining apparatus in this embodiment of this application may be UE, for example, UE with an operating system, or may be a component in UE, for example, an integrated circuit or a chip. The UE may be a terminal, or may be other devices than a terminal. For example, the UE may include but is not limited to the foregoing illustrated type of the UE 11. The other devices may be a server, a network attached storage (NAS), and the like. This is not limited in this embodiment of this application.

Optionally, as shown in FIG. 21, an embodiment of this application further provides a communication device 5000, including a processor 5001 and a memory 5002, where the memory 5002 stores a program or instructions executable on the processor 5001. For example, when the communication device 5000 is UE, and the program or instructions are executed by the processor 5001, the steps of the foregoing UE-side method embodiment are implemented, with the same technical effect achieved. To avoid repetition, details are not described herein again.

An embodiment of this application further provides UE. The UE includes a processor and a communication interface. The processor is configured to: determine at least one of a pattern or a starting symbol of an SL reference signal based on first information, where the first information includes at least one of the following: a total number of symbols used for SL transmission in a slot, resource indication information of the SL reference signal, resource pool type information, or time division multiplexing enable information; the time division multiplexing enable information represents that a slot includes at least two time domain candidate positions or at least two candidate time domain mapping patterns; and the resource pool type information represents a dedicated resource pool or a shared resource pool used for transmitting the SL reference signal. The UE embodiment corresponds to the foregoing UE-side method embodiment, and each implementation process and implementation of the foregoing method embodiment can be applied to the UE embodiment, with the same technical effect achieved.

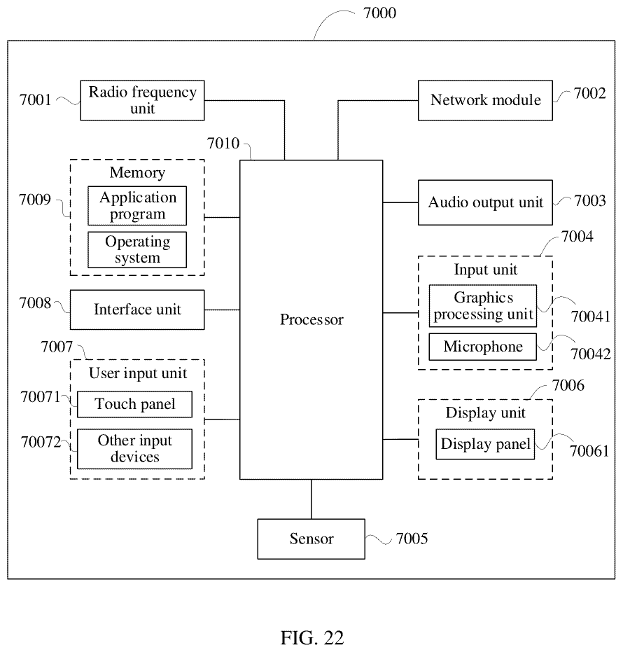

Optionally, FIG. 22 is a schematic diagram of a hardware structure of UE for implementing an embodiment of this application.

The UE 7000 includes but is not limited to at least some components such as a radio frequency unit 7001, a network module 7002, an audio output unit 7003, an input unit 7004, a sensor 7005, a display unit 7006, a user input unit 7007, an interface unit 7008, a memory 7009, and a processor 7010.

A person skilled in the art may understand that the UE 7000 may further include a power supply (such as a battery) for supplying power to the components. The power supply may be logically connected to the processor 7010 through a power management system. In this way, functions such as charge management, discharge management, and power consumption management are implemented by using the power management system. The structure of the UE shown in FIG. 22 does not constitute a limitation on the UE. The UE may include more or fewer components than those shown in the figure, or some components are combined, or component arrangements are different. Details are not described herein again.

It should be understood that, in this embodiment of this application, the input unit 7004 may include a graphics processing unit (GPU) 70041 and a microphone 70042. The graphics processing unit 70041 processes image data of a still picture or video obtained by an image capture apparatus (such as a camera) in a video capture mode or an image capture mode. The display unit 7006 may include a display panel 70061, and the display panel 70061 may be configured in a form of a liquid crystal display, an organic light-emitting diode, or the like. The user input unit 7007 includes at least one of a touch panel 70071 or other input devices 70072. The touch panel 70071 is also referred to as a touchscreen. The touch panel 70071 may include two parts: a touch detection apparatus and a touch controller. The other input devices 70072 may include but are not limited to a physical keyboard, a function button (such as a volume control button or a power button), a trackball, a mouse, and a joystick. Details are not described herein again.

In this embodiment of this application, after receiving downlink data from a network-side device, the radio frequency unit 7001 may transmit the downlink data to the processor 7010 for processing. In addition, the radio frequency unit 7001 may send uplink data to the network-side device. Usually, the radio frequency unit 7001 includes but is not limited to an antenna, an amplifier, a transceiver, a coupler, a low noise amplifier, a duplexer, and the like.

The memory 7009 may be configured to store software programs or instructions and various data. The memory 7009 may primarily include a first storage area for storing programs or instructions and a second storage area for storing data. The first storage area may store an operating system, an application program or instructions required by at least one function (such as an audio play function and an image play function), and the like. In addition, the memory 7009 may include a volatile memory or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data rate SDRAM, DDR SDRAM), an enhanced synchronous dynamic random access memory (Enhanced SDRAM, ESDRAM), a synchlink dynamic random access memory (Synch Link DRAM, SLDRAM), and a direct rambus random access memory (Direct Rambus RAM, DRRAM). The memory 7009 in this embodiment of this application includes but is not limited to these and any other suitable types of memories.

The processor 7010 may include one or more processing units. Optionally, the processor 7010 integrates an application processor and a modem processor. The application processor mainly processes operations related to the operating system, a user interface, an application program, and the like. The modem processor mainly processes a wireless communication signal. For example, the modem processor is a baseband processor. It may be understood that the modem processor may alternatively be not integrated in the processor 7010.

The processor 7010 is configured to determine at least one of a pattern or a starting symbol of an SL reference signal based on first information, where the first information includes at least one of the following: a total number of symbols used for SL transmission in a slot, resource indication information of the SL reference signal, resource pool type information, or time division multiplexing enable information; the time division multiplexing enable information represents that a slot includes at least two time domain candidate positions or at least two candidate time domain mapping patterns; and the resource pool type information represents a dedicated resource pool or a shared resource pool used for transmitting the SL reference signal.

According to the UE provided in this embodiment of this application, the UE may determine at least one of the pattern or the starting symbol of the SL reference signal based on the first information, where the first information includes at least one of the following: the total number of symbols used for SL transmission in the slot, the resource indication information of the SL reference signal, the resource pool type information, or the time division multiplexing enable information. Therefore, by designing a resource structure of the SL reference signal, this solution can maximize resource utilization of a resource pool with different symbols. In addition, in the shared resource pool, backward compatibility with R16/R17 UE in the shared resource pool is ensured, and sharing for SL positioning in the shared resource pool for R18 UE can be implemented.

Optionally, in this embodiment of this application, in a case that the total number of symbols is greater than N, the slot includes at least two time domain candidate positions of SL reference signals, and N is an integer greater than or equal to 7.

Optionally, in this embodiment of this application, the processor 7010 is configured to perform at least one of the following:
determining a time domain mapping pattern of a control channel and the SL reference signal in the slot based on the first information;
determining a frequency domain mapping pattern of a control channel and the SL reference signal in the slot based on the first information; or
determining a mapping relationship between patterns of a control channel and the SL reference signal in the slot based on the first information.

Optionally, in this embodiment of this application, the time domain mapping pattern of the control channel and the SL reference signal in the slot includes at least one of the following time domain mapping patterns: a first type of time domain mapping pattern; a second type of time domain mapping pattern; or a third type of time domain mapping pattern, where
the first type includes a time domain position of a control channel with N1 symbols and at least two time domain positions of SL reference signals, where the control channel with N1 symbols is mapped to first N1 symbols in the slot, a guard period GP symbol exists between the at least two time domain positions of the SL reference signals, and NI is a positive integer less than or equal to N;
the second type includes a time domain position of a control channel with N1 symbols and at least two time domain positions of SL reference signals, where the control channel with N1 symbols is mapped to first NI symbols in the slot, no GP symbol exists between the at least two time domain positions of the SL reference signals, and N1 is a positive integer less than or equal to N; and
the third type is that the slot is divided into two mini-slots, where each mini-slot includes a control channel and an SL reference signal.

Optionally, in this embodiment of this application, for odd symbols in the slot, a time domain mapping pattern of the odd symbols is the first type of time domain mapping pattern; or
for even symbols in the slot, a time domain mapping pattern of the even symbols is the second type of time domain mapping pattern; or
for even symbols in the slot, a time domain mapping pattern of the even symbols is the third type of time domain mapping pattern.

Optionally, in this embodiment of this application, the at least two time domain candidate positions of the SL reference signals have a same SL reference signal pattern.

Optionally, in this embodiment of this application, the SL reference signal pattern includes at least one of the following: a number of symbols of the SL reference signal; a comb size of the SL reference signal; a number of automatic gain control AGC symbols associated with the SL reference signal; a number of GP symbols associated with the SL reference signal; or an association rule between a PSCCH and the SL reference signal.

Optionally, in this embodiment of this application, the at least two time domain candidate positions of the SL reference signals have different SL reference signal patterns.

Optionally, in this embodiment of this application, the different SL reference signal patterns are that the SL reference signals have different starting symbols and different numbers of symbols.

Optionally, in this embodiment of this application, the SL reference signal patterns include at least two SL reference signal patterns, and the at least two SL reference signal patterns are configured in a same resource pool.

Optionally, in this embodiment of this application, the at least two SL reference signal patterns include frequency domain mapping patterns, and the frequency domain mapping pattern includes at least one of a comb size or a resource element RE offset.

Optionally, in this embodiment of this application, the slot includes multiple frequency domain mapping patterns, and comb sizes of the multiple frequency domain mapping patterns are the same.

Optionally, in this embodiment of this application, up to K SL reference signal patterns are included in a same resource pool, K is a maximum number of SL reference signal patterns supported in the same resource pool, and K is an integer greater than 1.

Optionally, in this embodiment of this application, each SL reference signal pattern is associated with indication information of an SL reference signal; or
each SL reference signal pattern is associated with an SL reference signal starting symbol of the respective SL reference signal pattern; or
each SL reference signal pattern is associated with an RE offset of the respective SL reference signal pattern; or
each SL reference signal pattern is associated with a number of symbols of the respective SL reference signal pattern.

Optionally, in this embodiment of this application, the time domain mapping pattern of the control channel and the SL reference signal in the slot includes a mini-slot structure configuration, where each mini-slot indicates a number of symbols of the mini-slot; or each mini-slot indicates a time domain mapping pattern of a control channel and an SL reference signal in the mini-slot.

Optionally, in this embodiment of this application, in a case that the number of symbols of each mini-slot is the same, at least one of a number of symbols or a comb size of the SL reference signal is the same; or in a case that the number of symbols of each mini-slot is different, at least one of a number of symbols of the SL reference signal or a number of symbols of a physical sidelink control channel PSCCH is different.

Optionally, in this embodiment of this application, each SL reference signal pattern is associated with mini-slot indication information of the SL reference signal pattern, and the mini-slot indication information is used to indicate that the mini-slot is a first mini-slot or a second mini-slot of the slot.

Optionally, in this embodiment of this application, the processor 7010 is configured to: determine indication information of the SL reference signal based on the first information and detection of candidate resources for the SL reference signal, where each SL reference signal pattern is associated with indication information of an SL reference signal; or determine, based on the first information and detection of candidate resources for a PSCCH associated with the SL reference signal, a position of the PSCCH associated with the SL reference signal, to determine at least one of the pattern or the starting symbol of the SL reference signal.

Optionally, in this embodiment of this application, after determining the indication information of the SL reference signal based on the first information and detection of the candidate resources for the SL reference signal, the processor 7010 is further configured to determine indication information of sidelink control information SCI, where the SCI includes the indication information of the SL reference signal.

Optionally, in this embodiment of this application, after determining the indication information of the SL reference signal based on the first information and detection of the candidate resources for the SL reference signal, the processor 7010 is further configured to determine, based on the indication information of the SL reference signal, a frequency domain position or a time domain position of the PSCCH associated with the SL reference signal.

Optionally, in this embodiment of this application, the frequency domain position or the time domain position of the PSCCH includes:
a PSCCH corresponding to i-th indication information of an SL reference signal is located in an i-th PSCCH minimum unit, where i is a positive integer; or
a PSCCH corresponding to i-th indication information of an SL reference signal is located in a mod(i+N1, K1)-th PSCCH minimum unit, where i is a positive integer, K1 is a maximum frequency domain candidate position of the PSCCH, and N1 is a frequency shift parameter of the PSCCH.

Optionally, in this embodiment of this application, the frequency domain position or the time domain position of the PSCCH includes:
in a case that the indication information of the SL reference signal is local information in each mini-slot, a PSCCH corresponding to i-th indication information of an SL reference signal is located in an i-th PSCCH minimum unit in a current mini-slot, where i is a positive integer; or
in a case that the indication information of the SL reference signal is local information in each slot, a PSCCH corresponding to i-th indication information of an SL reference signal is located in a mod(i, F)-th PSCCH minimum unit in a current mini-slot, where i is a positive integer, and F is a maximum number of SL reference signals in a mini-slot.

Optionally, in this embodiment of this application, a time domain mapping pattern of the SL reference signal is determined based on a protocol or a specified table, where
the table includes at least one of the following: a number of symbols used for SL transmission in the slot, the starting symbol of the SL reference signal, a number of symbols of the SL reference signal, or a number of symbols of a PSCCH.

Optionally, in this embodiment of this application, in a case that time division multiplexing mapping is not enabled, the SL reference signal pattern includes only a frequency domain mapping pattern, and the frequency domain mapping pattern is associated with at least one piece of the following information: indication information of the SL reference signal or an RE offset of the SL reference signal pattern.

Optionally, in this embodiment of this application, the first information includes at least the resource pool type information, and the resource pool type information represents the shared resource pool used for transmitting the SL reference signal. The processor 7010 is configured to: in a case that the SL reference signal is mapped to the shared resource pool, determine at least one of the pattern or the starting symbol of the SL reference signal based on whether a symbol used for SL transmission in the slot is used for transmission of a physical sidelink shared channel PSSCH.

Optionally, in this embodiment of this application, the processor 7010 is configured to: in a case that the symbol used for SL transmission in the slot is used for transmission of the PSSCH, determine a mapping pattern of a control channel, the PSSCH, and the SL reference signal in the slot.

Optionally, in this embodiment of this application, the mapping pattern of the SL reference signal in the slot includes a symbol position of the SL reference signal, where the SL reference signal is mapped to M symbols after a first demodulation reference signal DMRS after a PSCCH; or the SL reference signal is mapped to M symbols between a first DMRS and a second DMRS after a PSCCH.

Optionally, in this embodiment of this application, in a case that the SL reference signal is mapped to the M symbols between the first DMRS and the second DMRS after the PSCCH, a time domain length and a comb size of the SL reference signal are provided by a resource pool configuration and determined with reference to positions of the DMRSs.

Optionally, in this embodiment of this application, a mapping pattern of the control channel and the PSSCH in the slot includes one of the following that: there is symbol overlap between the control channel and the PSSCH in the slot; and there is no symbol overlap between the control channel and the PSSCH in the slot.

Optionally, in this embodiment of this application, in a case that there is no symbol overlap between the control channel and the PSSCH in the slot, a bandwidth or a frequency domain position of the PSSCH is the same as that of a PSCCH.

Optionally, in this embodiment of this application, in a case that the bandwidth or the frequency domain position of the PSSCH is the same as that of the PSCCH, a multi-user PSCCH can be mapped to a same time domain position but different frequency domain positions, where up to K1 users can be mapped to one slot, and K1 is a maximum frequency domain candidate position of the PSCCH.

Optionally, in this embodiment of this application, in a case that there is symbol overlap between the control channel and the PSSCH in the slot, a bandwidth or a frequency domain position of the PSSCH is the same as that of the SL reference signal.

Optionally, in this embodiment of this application, in a case that the bandwidth or the frequency domain position of the PSSCH is the same as that of the SL reference signal, multi-user multiplexing is not supported within a resource of the SL reference signal.

Optionally, in this embodiment of this application, in a case that detection and resource selection of the shared resource pool are determined based on a DMRS of the PSSCH, and that a symbol of the DMRS includes a first symbol, SL reference signal mapping at a comb level is not supported in the slot; or
in a case that detection and resource selection of the shared resource pool are determined based on a DMRS of a PSCCH, frequency division multiplexing FDM SL reference signal mapping at a comb level is supported in the slot.

Optionally, in this embodiment of this application, in a case that the detection and resource selection of the shared resource pool are determined based on the DMRS of the PSSCH, FDM SL reference signal transmission at the comb level is not supported in a first resource pool, where the first resource pool is a resource pool in which a number of symbols for the SL reference signal is less than or equal to L, and L is an integer greater than 7.

Optionally, in this embodiment of this application, in a case that the detection and resource selection of the shared resource pool are determined based on the DMRS of the PSCCH, and that the slot used for transmitting the SL reference signal does not include the PSSCH, the SL reference signal can be mapped to a symbol in which the DMRS of the PSSCH is located.

The UE provided in this embodiment of this application can implement each process implemented by the UE in the foregoing method embodiment, with the same technical effect achieved. To avoid repetition, details are not described herein again.

An embodiment of this application further provides a non-transitory readable storage medium. The non-transitory readable storage medium stores a program or instructions. When the program or instructions are executed by a processor, each process of the foregoing embodiment of the mapping resource determining method is implemented, with the same technical effect achieved. To avoid repetition, details are not described herein again.

The processor is a processor in the communication device in the foregoing embodiment. The non-transitory readable storage medium includes a non-transitory computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing method embodiment, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a non-transitory storage medium. The computer program or program product is executed by at least one processor to implement each process of the foregoing method embodiment, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

Based on the foregoing descriptions of the implementations, a person skilled in the art may clearly understand that the foregoing embodiment methods can be implemented by using a computer software product in combination with a necessary general hardware platform, or by using hardware only. The computer software product is stored in a storage medium (such as a ROM, a RAM, a magnetic disk, or an optical disc), and includes several instructions for instructing a terminal or a network-side device to perform the methods described in the embodiments of this application.

The foregoing describes the embodiments of this application with reference to the accompanying drawings. However, this application is not limited to the foregoing embodiments. The foregoing embodiments are merely illustrative rather than restrictive. Inspired by this application, a person of ordinary skill in the art may develop many other manners of embodiments without departing from principles of this application and the protection scope of the claims, and all such manners of embodiments fall within the protection scope of this application.

What is claimed is:

1. A mapping resource determining method, comprising:
determining at least one of a pattern or a starting symbol of a sidelink (SL) reference signal based on first information, wherein
the first information comprises at least one of the following: a total number of symbols used for SL transmission in a slot, resource indication information of the SL reference signal, resource pool type information, or time division multiplexing enable information; the time division multiplexing enable information represents that a slot comprises at least two time domain candidate positions or at least two candidate time domain mapping patterns; and the resource pool type information represents a dedicated resource pool or a shared resource pool used for the SL reference signal transmission.

2. The method according to claim 1, wherein in a case that the total number of symbols is greater than N, the slot comprises at least two time domain candidate positions of SL reference signals, and N is an integer greater than or equal to 7.

3. The method according to claim 1, wherein the determining a pattern of an SL reference signal based on first information comprises at least one of the following:
determining a time domain mapping pattern of a control channel and the SL reference signal in the slot based on the first information;
determining a frequency domain mapping pattern of a control channel and the SL reference signal in the slot based on the first information; or
determining a mapping relationship between patterns of a control channel and the SL reference signal in the slot based on the first information;
wherein the time domain mapping pattern of the control channel and the SL reference signal in the slot comprises: a second type of time domain mapping pattern; wherein the second type comprises a time domain position of a control channel with N1 symbols and at least two time domain positions of SL reference signals, wherein the control channel with N1 symbols is mapped to first N1 symbols in the slot, no guard period (GP) symbol exists between at least two the time domain positions of the SL reference signals, and N1 is a positive integer less than or equal to N.

4. The method according to claim 1, wherein one slot comprises a plurality of automatic gain control (AGC) symbols and one guard period (GP) symbol, wherein the one GP symbol is located at a last symbol of the slot.

5. The method according to claim 3, wherein the time domain mapping pattern of the control channel and the SL reference signal in the slot meets at least one of the following that: for odd symbols in the slot, a time domain mapping pattern of the odd symbols is the first type of time domain mapping pattern;
for even symbols in the slot, a time domain mapping pattern of the even symbols is the second type of time domain mapping pattern; or
for the even symbols in the slot, the time domain mapping pattern of the even symbols is the third type of time domain mapping pattern.

6. The method according to claim 2, wherein the at least two time domain candidate positions of the SL reference signals have a same SL reference signal pattern, wherein a same mapping pattern is the same (M, N), N is a comb size of the SL reference signal; and M is a number of symbols of the SL reference signal; or,
the at least two time domain candidate positions of the SL reference signals have different SL reference signal patterns, wherein the different SL reference signal patterns are that at least one of the comb size or the number of symbols of the SL reference signal is different.

7. The method according to claim 2, wherein if starting symbols associated with two SL reference signal patterns are the same, numbers of symbols associated with the SL reference signal patterns are also the same.

8. The method according to claim 1, wherein the SL reference signal patterns comprise at least two SL reference signal patterns, and the at least two SL reference signal patterns are configured in a same resource pool;
wherein the at least two SL reference signal patterns comprise frequency domain mapping patterns, and the frequency domain mapping pattern comprises at least one of a comb size or a resource element (RE) offset;
wherein the slot comprises multiple frequency domain mapping patterns, and comb sizes of the multiple frequency domain mapping patterns are the same.

9. The method according to claim 1, wherein up to K SL reference signal patterns are comprised in a same resource pool, K is a maximum number of SL reference signal patterns supported in the same resource pool, and K is an integer greater than 1;
wherein each SL reference signal pattern is associated with indication information of an SL reference signal; or
each SL reference signal pattern is associated with an SL reference signal starting symbol of the respective SL reference signal pattern; or
each SL reference signal pattern is associated with an RE offset of the respective SL reference signal pattern; or
each SL reference signal pattern is associated with a number of symbols of the SL reference signal pattern.

10. The method according to claim 9, wherein the determining at least one of a pattern or a starting symbol of an SL reference signal based on first information comprises:
determining indication information of the SL reference signal based on the first information and detection of candidate resources for the SL reference signal, wherein each SL reference signal pattern is associated with indication information of an SL reference signal; or
determining, based on the first information and detection of candidate resources for a physical sidelink control channel (PSCCH) associated with the SL reference signal, a position of the PSCCH associated with the SL reference signal, to determine at least one of the pattern or the starting symbol of the SL reference signal.

11. The method according to claim 10, wherein after the determining indication information of the SL reference signal based on the first information and detection of candidate resources for the SL reference signal, the method further comprises:
determining indication information of sidelink control information (SCI), wherein the SCI comprises the indication information of the SL reference signal.

12. The method according to claim 10, wherein after the determining indication information of the SL reference signal based on the first information and detection of candidate resources for the SL reference signal, the method further comprises:
determining, based on the indication information of the SL reference signal, a frequency domain position or a time domain position of the PSCCH associated with the SL reference signal.

13. The method according to claim 12, wherein the frequency domain position or the time domain position of the PSCCH comprises:
a PSCCH corresponding to i-th indication information of an SL reference signal is located in an i-th PSCCH minimum unit, wherein i is a positive integer, wherein the minimum unit is a subchannel; or,
a receiving user equipment (UE) determines the indication information of the SL reference signal based on the frequency domain position of the PSCCH.

14. The method according to claim 1, wherein a time domain mapping pattern of the SL reference signal is determined based on a protocol or a specified table, wherein
the table comprises at least one of the following: a number of symbols used for SL transmission in the slot, the starting symbol of the SL reference signal, a number of symbols of the SL reference signal, or a number of symbols of a physical sidelink control channel (PSCCH).

15. The method according to claim 1, wherein the determining a pattern of an SL reference signal based on first information comprises:
in a case that a symbol used for SL transmission in the slot is used for transmission of a physical sidelink shared channel (PSSCH), determining a mapping pattern of a control channel, the PSSCH, and the SL reference signal in the slot.

16. The method according to claim 15, wherein the mapping pattern of the SL reference signal in the slot comprises a symbol position of the SL reference signal, wherein
the SL reference signal is mapped to M symbols after a first demodulation reference signal (DMRS) after a physical sidelink control channel (PSCCH), wherein M is a positive integer; or
the SL reference signal is mapped to M symbols between a first DMRS and a second DMRS after a PSCCH, wherein M is a positive integer;
wherein M is a number of symbols of the SL reference signal.

17. The method according to claim 15, wherein a mapping pattern of the control channel and the PSSCH in the slot comprises one of the following that:
there is symbol overlap between the control channel and the PSSCH in the slot; and
there is no symbol overlap between the control channel and the PSSCH in the slot;
wherein in a case that there is symbol overlap between the control channel and the PSSCH in the slot, a bandwidth or a frequency domain position of the PSSCH is the same as a bandwidth or a frequency domain position of the SL reference signal;
wherein in a case that the bandwidth or the frequency domain position of the PSSCH is the same as the bandwidth or the frequency domain position of the SL reference signal, multi-user multiplexing is not supported within a resource of the SL reference signal.

18. The method according to claim 15, wherein in a case that detection and resource selection of the shared resource pool are determined based on a demodulation reference signal (DMRS) of the PSSCH, and that a symbol of the DMRS comprises a first symbol, SL reference signal mapping at a comb level is not supported in the slot;
wherein in a case that the detection and resource selection of the shared resource pool are determined based on the DMRS of the PSSCH, FDM SL reference signal transmission at the comb level is not supported in a first resource pool, wherein the first resource pool is a resource pool in which a number of symbols for the SL reference signal is less than or equal to L, and Lis an integer greater than 7.

19. A user equipment (UE), comprising a processor and a memory, wherein the memory stores a program or instructions executable on the processor, and the program or instructions, when executed by the processor, cause the UE to perform:
determining at least one of a pattern or a starting symbol of a sidelink (SL) reference signal based on first information, wherein
the first information comprises at least one of the following: a total number of symbols used for SL transmission in a slot, resource indication information of the SL reference signal, resource pool type information, or time division multiplexing enable information; the time division multiplexing enable information represents that a slot comprises at least two time domain candidate positions or at least two candidate time domain mapping patterns; and the resource pool type information represents a dedicated resource pool or a shared resource pool used for the SL reference signal transmission.

20. A non-transitory readable storage medium, wherein the non-transitory readable storage medium stores a program or instructions, and the program or instructions, when executed by a processor of a user equipment (UE), cause the UE to perform:
determining at least one of a pattern or a starting symbol of a sidelink (SL) reference signal based on first information, wherein
the first information comprises at least one of the following: a total number of symbols used for SL transmission in a slot, resource indication information of the SL reference signal, resource pool type information, or time division multiplexing enable information; the time division multiplexing enable information represents that a slot comprises at least two time domain candidate positions or at least two candidate time domain mapping patterns; and the resource pool type information represents a dedicated resource pool or a shared resource pool used for the SL reference signal transmission.
